(19) United States
(12) Patent Application Publication
(10) Pub. No.: US 2026/0290382 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/568,855

(22) Filed: Mar. 17, 2026

(30) Foreign Application Priority Data
Mar. 19, 2025 (JP) 2025-045214

(51) Int. Cl. G10L 25/63; G06V 40/16

(52) U.S. Cl. CPC G10L 25/63; G06V 40/176

(57) ABSTRACT

A system includes circuitry configured to receive, via a packet-switched network, a prompt sentence representing a natural language question from a terminal device and preprocess the prompt sentence using natural language processing including document structure analysis, term extraction, and identification of attributes such as a period and an instrument type. The circuitry acquires related information from an external information processing apparatus, stores the information, and performs numerical computation to update numerical indicators and ratios. Based on retrieved data and the preprocessed prompt sentence, the circuitry generates a prompt for a generative AI model to produce explanatory content and transmits the explanatory content to the terminal device. Sensor data from the terminal device is analyzed using an emotion recognition model to adjust tone or content of subsequent explanatory content.

### CROSS-REFERENCE TO RELATED APPLICATION

This application is based on and claims priority under 35 USC 119 from Japanese Patent Application No. 2025-045214 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional financial education and analysis systems mainly provide static explanations of financial concepts and simple display of analysis results. Such systems do not flexibly generate explanations tailored to the specific content of a user's question, and therefore often fail to provide detailed and context-appropriate explanations of particular financial concepts. Furthermore, conventional systems generally do not recognize the emotional state of the user from voice tone or facial expression, and thus cannot adapt the tone or depth of explanations to match user anxiety, confusion, or confidence. As a result, the user experience is limited, comprehension may be reduced, and the system may not effectively support learning or decision-making.
In addition, conventional systems often provide only fixed, predefined warnings regarding financial risks and are not capable of dynamically generating warning messages that reflect the individual financial data of the user. This makes it difficult to appropriately alert the user to specific financial risks tailored to the user's situation. Accordingly, there is a need for a system that can (i) analyze natural-language questions, (ii) dynamically generate explanations of specific financial concepts through a generative AI model, (iii) recognize the user's emotional state and adapt the explanation, and (iv) generate personalized warning messages regarding financial risks based on the user's financial data.

### SUMMARY

In order to solve the above-described problems, according to one aspect of the present invention, there is provided a system comprising a processor, wherein the processor is configured to provide an interface for accepting a question from a user, analyze the accepted question using natural language processing technology, and acquire related information from a database. The processor is further configured to generate, based on the acquired information, a prompt for instructing generation of an explanation regarding a specific financial concept, and to input the prompt to a generative AI model so that an explanation tailored to the user's question is generated.
In one embodiment, the processor is configured to present the generated explanation to the user, analyze a tone of voice or a facial expression of the user to recognize an emotion of the user, and adjust a tone or content of the explanation in accordance with the recognized emotion. In another embodiment, the processor is configured to analyze financial data of the user, generate a prompt for instructing generation of a warning message regarding a specific financial risk based on a result of the analysis, and input the prompt to the generative AI model. By these means, the system can dynamically generate context-appropriate explanations of financial concepts and personalized warning messages regarding financial risks, and can adapt such explanations and warnings to the emotional state and financial situation of the user.

The term “system” refers to a combination of hardware and software components configured to execute processing defined in the claims, including at least one processor and, optionally, memory, storage, input/output devices, and communication interfaces.
The term “processor” refers to any hardware component or set of components capable of executing instructions, including but not limited to a central processing unit (CPU), a graphics processing unit (GPU), an application-specific integrated circuit (ASIC), a field-programmable gate array (FPGA), or a combination thereof.
The term “interface” refers to a hardware and/or software component that enables input of information by a user and/or output of information to a user, including but not limited to a graphical user interface, a web interface, a command line interface, a touch interface, or a voice-based interface.
The term “question from a user” refers to an input expressed in natural language by the user for the purpose of requesting information, analysis, or explanation regarding a financial concept or financial situation.
The term “natural language processing technology” refers to a set of algorithms, models, and techniques for processing and understanding human language text or speech, including but not limited to tokenization, parsing, part-of-speech tagging, named entity recognition, intent detection, and semantic analysis.
The term “database” refers to any organized collection of data that can be stored, searched, and retrieved by the processor, including but not limited to relational databases, non-relational databases, in-memory data stores, and knowledge bases.
The term “related information” refers to data or knowledge items retrieved from the database that are relevant to the content and intent of the user's question, including but not limited to definitions, explanations, formulas, examples, historical data, and financial indicators.
The term “prompt” refers to data generated by the processor that describes a task or instruction for a generative AI model, including but not limited to a text string specifying what explanation or warning message should be generated, and optionally including context, constraints, or example outputs.
The term “generative AI model” refers to a machine learning model configured to generate outputs such as text based on input data, including but not limited to a large language model, a transformer-based model, or another neural network-based generative model.
The term “specific financial concept” refers to a defined notion or item in the field of finance, including but not limited to free cash flow, debt-to-equity ratio, equity ratio, interest coverage ratio, and other financial terms, indicators, or theories.
The term “explanation” refers to text or other content generated for the purpose of describing, clarifying, or interpreting a specific financial concept or financial risk in a form understandable to the user.
The term “present the generated explanation to the user” refers to outputting the explanation through the interface, including but not limited to displaying text on a screen, providing audio output, or presenting the explanation using graphical or multimodal means.
The term “tone of voice” refers to acoustic characteristics of the user's speech, such as pitch, volume, speed, and intonation, which can be analyzed to infer emotional states such as anxiety, confusion, or confidence.
The term “facial expression” refers to visual features of the user's face, such as eye movement, mouth shape, and overall expression, which can be captured and analyzed by sensors or cameras to infer the user's emotional state.
The term “emotion of the user” refers to an inferred psychological state of the user, including but not limited to anxiety, confusion, interest, satisfaction, and confidence, which is recognized based on analysis of the user's tone of voice or facial expression.
The term “tone of the explanation” refers to a style or manner of presentation of the explanation, including but not limited to the level of formality, degree of encouragement, sense of urgency, and level of detail or simplification.
The term “content of the explanation” refers to the substantive information included in the explanation, such as the selected concepts, level of technical detail, examples provided, and the structure or order of the presented information.
The term “financial data of the user” refers to data representing the user's financial situation, including but not limited to income, expenses, assets, liabilities, investment positions, credit information, and transaction history.
The term “specific financial risk” refers to a defined type of risk related to the user's financial situation, including but not limited to liquidity risk, credit risk, market risk, interest rate risk, and concentration risk.
The term “warning message” refers to information generated to alert the user to the presence or possibility of a specific financial risk, including an indication of the risk, its potential impact, and optionally suggestions or recommendations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

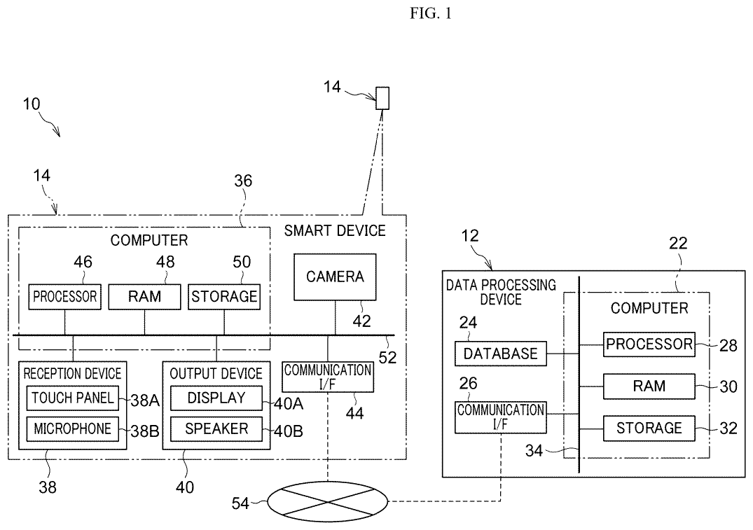

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

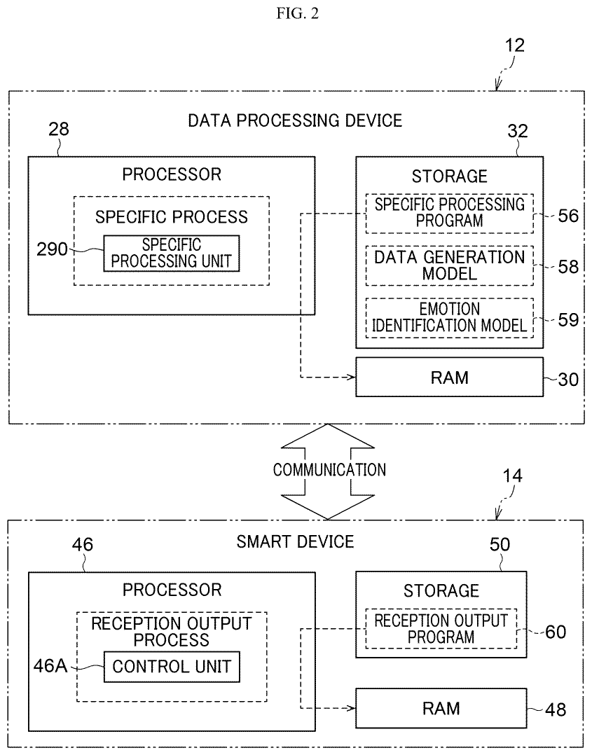

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented financial explanation systems suffer from several technical limitations in how user queries are processed and how explanatory content is generated and adapted.
First, in many existing systems, a user query is treated as a simple keyword search request. A server typically passes the keywords directly to a database or a static rule engine, and the resulting information is returned with minimal transformation. This architecture does not structurally integrate dynamic numerical computation, contextual financial data retrieval, and natural language generation. As a result, the processor of such systems mainly performs straightforward data lookups, and the interaction pipeline between input acquisition, data processing, and output generation is loosely coupled and inefficient from a system-level perspective.
Second, known systems that incorporate natural language generation often send raw user text directly to a generative AI model. The server does not construct a structured, machine-oriented generation prompt sentence that explicitly encodes financial concepts to be explained, numerical values to be used, a desired explanation depth, and an output format. Without such structured prompt construction, the generative AI model is not effectively constrained by the actual data stored in the system, which may result in responses that are inconsistent with current database contents and that require additional post-processing. This leads to increased processing overhead on the server and non-deterministic latency in generating responses.
Third, typical systems lack an integrated mechanism by which evaluation information from users is fed back into the internal prompt construction logic in a systematic, machine-driven manner. User feedback, when captured at all, is usually stored as unstructured logs or survey data that are not directly utilized by the processor to adapt the configuration rules for generation prompt sentences. Consequently, the system cannot automatically tune its prompt generation and model-instruction policies over time, and the computer's behavior remains static regardless of recurrent patterns in user interactions.
Fourth, existing architectures often separate explanation text generation from visualization data generation. The server may generate charts using a generic charting component that operates independently of the natural language explanation. In this case, time-series data or category data are prepared in an ad hoc fashion, and there is no unified data-processing pipeline that simultaneously derives both the explanatory narrative and the corresponding structured visualization data from the same intermediate computation results. This fragmented approach increases redundancy in computation and memory usage and complicates synchronization between textual and graphical outputs.
Fifth, systems that offer multi-modal outputs, such as text and audio, typically treat audio generation as a peripheral feature implemented at the client side or in a separate service. Without explicit control by the processor over how explanation text is formatted for audio synthesis and how audio-related evaluation information is collected and fed back, the overall interaction loop becomes fragmented. The server is not architected to manage text formatting, visualization data structuring, and audio preparation as part of a unified processing flow, which results in duplicated implementation and suboptimal use of computing resources. Accordingly, there is a need for a computer-implemented system in which a processor orchestrates, in an integrated and technically efficient manner, (i) acquisition of user prompt sentences via a terminal device, (ii) retrieval and numerical processing of financial information stored in a storage device, (iii) construction of structured generation prompt sentences for a generative AI model, (iv) generation of explanation information and coordinated visualization data based on the model output and computed indicators, and (v) adaptive updating of the prompt construction rules and instruction content in response to accumulated user evaluation information. There is also a need to improve the internal data flow and processing configuration such that the computer itself is technically improved in terms of resource usage, responsiveness, and robustness of the generated financial explanations and visualizations.

The specific processing by the specific processing unit 290 of the data processing device 12 in Example 1 is realized by the following means.

The present invention provides a server comprising a processor, a storage device, a communication interface, and a terminal interface, the processor being configured to provide, via the terminal interface, an input/output interface that receives, from a terminal device, a prompt sentence representing a natural language question from a user and that causes the terminal device to display an input field for the prompt sentence and a transmission control; to acquire, via the communication interface, financial information from an external information processing apparatus, to store the acquired financial information in the storage device, and to perform numerical computation on the stored financial information so as to calculate and update financial indicators and financial ratios; to preprocess, by using a natural language processing technique, the prompt sentence received from the user, the preprocessing including document structure analysis, term extraction, and identification of attributes including a period and a financial instrument, and to retrieve, from the storage device, data related to the prompt sentence from among the stored financial information; to generate, based on the retrieved financial information and the calculated financial indicators, a generation prompt sentence to be input to a generative AI model, the generation prompt sentence including instruction information that defines a financial concept to be explained, numerical data to be used, a level of detail of an explanation, and an output format; to transmit the generation prompt sentence to the generative AI model via the communication interface, to obtain an explanation text output from the generative AI model, and to perform formatting processing and numerical-example insertion processing on the explanation text so as to generate explanation information regarding the financial concept; to extract, as visualization data corresponding to the explanation information, time-series data and category data from the financial information and the financial indicators, and to generate structured data for graph display or table display on the terminal device; to cause the terminal device to present the explanation information and visual information based on the structured data to the user as a textual display and a graphical display, and to receive, from the terminal device, evaluation information and an additional prompt sentence from the user and to store the evaluation information and the additional prompt sentence in the storage device; and to update, on the basis of the stored evaluation information, a configuration rule of the generation prompt sentence and instruction content to the generative AI model so as to adjust content and a level of detail of a subsequent explanation generation process. This enables an improvement in computer functionality by providing an integrated processing pipeline in which the processor systematically coordinates natural language input handling, data retrieval and numerical computation, prompt sentence construction for a generative AI model, synchronized generation of explanatory and visualization outputs, and adaptive updating of internal control rules based on user feedback, thereby enhancing processing efficiency, response consistency with stored financial data, and the technical robustness of the interactive financial explanation system.

The term “processor” refers to one or more hardware-implemented processing units, such as a central processing unit or a computing core, configured to execute machine-readable instructions to perform data processing, control, and communication operations described in the present specification.
The term “storage device” refers to one or more computer-readable media, such as a memory device or a persistent storage apparatus, configured to store financial information, user information, prompt sentences, configuration rules, and program instructions used by the processor.
The term “communication interface” refers to a hardware and software communication component, such as a network interface and a communication protocol stack, configured to send and receive data between the server and external information processing apparatuses or terminal devices via an electric communication line.
The term “terminal device” refers to an information processing apparatus operated by a user, such as a client computer or a mobile communication device, configured to exchange data with the server and present input and output information to the user.
The term “terminal interface” refers to a logical interface implemented by the processor to control communication and data exchange with the terminal device, including generation and interpretation of messages transmitted between the server and the terminal device.
The term “input/output interface” refers to a software-controlled user interface presented on the terminal device, including display elements and input controls, through which a user enters information and receives information from the system.
The term “prompt sentence” refers to a natural language text string representing a question, request, or instruction provided by a user or generated by the processor for use as input to a generative AI model.
The term “external information processing apparatus” refers to a remote computing system or service, such as a data distribution server or an application service provider, configured to provide financial information or related data to the server via a communication network.
The term “financial information” refers to data representing financial conditions or activities of an entity or market, including but not limited to market prices, financial statements, cash flow data, and derived financial metrics.
The term “financial indicator” refers to a numerical value computed from financial information, such as a performance ratio, profitability index, liquidity indicator, or valuation metric.
The term “financial ratio” refers to a type of financial indicator expressed as a ratio of two or more financial quantities, such as a valuation ratio or a leverage ratio.
The term “natural language processing technique” refers to a computational method or algorithm used by the processor to analyze and manipulate human language text, including tokenization, parsing, entity recognition, and semantic interpretation.
The term “document structure analysis” refers to processing that identifies a structural organization of a text, including segmentation into sentences, paragraphs, or sections, and classification of components such as titles or emphasis.
The term “term extraction” refers to processing that identifies specific lexical items or expressions in a text, including domain-related terms such as names of financial concepts, instruments, or entities.
The term “attribute” refers to a parameter or property associated with content of a prompt sentence or financial information, such as a time period, a financial instrument identifier, or a data granularity.
The term “generation prompt sentence” refers to a prompt sentence constructed by the processor for input to a generative AI model, the prompt sentence including structured instruction information and contextual data used to control the behavior and output of the generative AI model.
The term “instruction information” refers to information embedded in a generation prompt sentence that specifies control conditions for the generative AI model, including an explanation target, a required detail level, an output format, and usage of numerical data.
The term “generative AI model” refers to a machine-learned model configured to generate natural language or other data content in response to input prompts, based on patterns learned from training data.
The term “explanation text” refers to natural language text output by the generative AI model, which describes or explains a financial concept or financial information in response to a generation prompt sentence.
The term “explanation information” refers to a processed form of explanation text, optionally including formatting, inserted numerical examples, and structural organization, prepared by the processor for presentation to a user.
The term “formatting processing” refers to operations that modify the layout or structure of text, such as inserting headings, lists, emphasis, or line breaks, to improve readability or compatibility with display or audio output.
The term “numerical-example insertion processing” refers to operations that insert, into explanation text, specific numerical values or calculation steps derived from financial information or financial indicators to concretely illustrate a financial concept.
The term “visualization data” refers to data derived from financial information and financial indicators, structured for use in generating visual representations, such as charts, graphs, or tables.
The term “time-series data” refers to data consisting of values of one or more variables indexed by time, used to represent temporal changes of financial quantities.
The term “category data” refers to data consisting of values associated with discrete categories or groups, such as types of cash flows, sectors, or financial statement items.
The term “structured data” refers to data organized in a defined format, such as records, arrays, or key-value pairs, suitable for direct use by a visualization component on the terminal device.
The term “visual information” refers to information presented to the user in graphical or tabular form, including charts, graphs, or tables generated from visualization data.
The term “evaluation information” refers to information indicating an assessment or feedback from the user regarding explanation information, visual information, or system behavior, including ratings, selections, or textual comments.
The term “additional prompt sentence” refers to a follow-up prompt sentence provided by the user after viewing explanation information, or generated internally by the processor, which is used to obtain further output from the generative AI model.
The term “configuration rule” refers to rule data or parameters stored in the storage device and used by the processor to determine how to construct generation prompt sentences, including selection of contextual data, instruction information, and formatting policies.
The term “instruction content” refers to a specific set of directives included in a generation prompt sentence that guide the generative AI model regarding the style, scope, and detail level of the generated explanation.
The term “subsequent explanation generation process” refers to a later execution of operations by the processor to generate new explanation information using the generative AI model, after previous user interactions and evaluation information have been taken into account.
The term “text information for audio output” refers to explanation text or related text content that is formatted and provided as input to an audio synthesis process for converting text into an audio signal.
The term “speech synthesis process” refers to a computational process that converts text information into an audio signal representing spoken language.
The term “audio signal” refers to a digital or analog representation of sound, including spoken explanations, that can be output by an audio output device of the terminal device.
The term “operation information” refers to data indicating operations performed by a user with respect to audio output or displayed information, such as playback control, repetition requests, or navigation commands.
The term “financial-related data” refers to data obtained from a user or from external sources that describes financial status, preferences, or conditions associated with the user or an entity, used in combination with financial information stored in the storage device.
The term “warning message regarding a specific financial risk” refers to explanation information generated to alert the user to a potential unfavorable financial condition or risk, derived from analysis of financial-related data and financial information.

In one embodiment, a server cooperates with one or more terminals operated by a user to implement the claimed system for generating data-consistent financial explanations using a generative AI model. The server includes a processor, a storage device, and a communication interface. The terminal includes a display, an input device, an audio output device, and a network interface.
The server executes software modules on a general-purpose computing platform, such as a rack-mounted computer with a multi-core central processing unit, a main memory, and a non-volatile storage unit. The server runs an operating system, such as a Unix-like operating system, and application software implemented, for example, using a web framework and a numerical computation library. The storage device stores financial information, user information, configuration rules for prompt construction, and logs of user interactions.
The terminal executes a client application, such as a web browser or a native mobile application, on a client computing device, such as a personal computer or a mobile communication device. The terminal displays a graphical user interface that allows the user to input a prompt sentence, view textual explanations, inspect graphical visualizations, and control audio playback.
The server provides, via the terminal, an input/output interface implemented, for example, as an HTML-based or native graphical user interface screen. The terminal displays an input text box, a “Send” button, and a region for explanation output. The user inputs a prompt sentence in natural language, such as:
“Please explain how to calculate PER and show a simple numerical example.”
“Please explain the basic structure of a cash flow statement and the key points to watch.”
“Compare PER values of two companies and tell me which looks more expensive.”
The terminal transmits the prompt sentence and optional parameters, such as a selected ticker or time period, to the server over a secure communication protocol. The server receives the prompt sentence through the communication interface and passes the data to an input processing module executed by the processor.
The server maintains, in the storage device, a set of data structures for financial information. In one embodiment, the server stores market price data and derived ratios in relational tables, each row containing a timestamp, an identifier for a financial instrument, a price value, and precomputed financial indicators, such as valuation ratios. The server stores financial statements in normalized tables for income, cash flows, and balance sheet items, where each record is associated with a reporting period and an entity identifier. The server uses an indexing scheme that accelerates retrieval for specific instruments and time ranges, thereby improving data access performance.
The server acquires financial information from an external information processing apparatus, such as a data distribution service, using an application programming interface. The server uses an HTTP client library to send data requests at scheduled intervals and stores the received financial data, which may be provided as structured records, in the storage device. The server executes numerical computations, such as division, aggregation, and difference operations, using a numerical computation library to calculate financial indicators and financial ratios. For example, the server calculates a valuation ratio by dividing a price by an earnings value associated with the instrument. The server writes the results back into a dedicated table, thus maintaining a cache of computed indicators that reduces the need for repeated computation and improves processing speed.
The server preprocesses the prompt sentence using a natural language processing pipeline. In one embodiment, the server loads a natural language model constructed using a tokenization and parsing library. The server performs tokenization, part-of-speech tagging, and syntactic parsing to identify sentence boundaries, key noun phrases, and verbs. The server identifies terms related to financial concepts, such as “cash flow statement,” “valuation ratio,” or “profitability ratio,” and extracts attributes such as time periods and instrument identifiers. For example, when the user enters “Compare PER values of two companies and tell me which looks more expensive,” the server detects that a comparison operation is requested, that a valuation ratio is the target concept, and that two distinct instrument identifiers may be needed from either the prompt sentence or additional user inputs.
The server retrieves, from the storage device, data that is related to the extracted terms and attributes. The server executes parameterized queries, using indexing on instrument identifiers and time fields, to obtain current and historical financial indicators. By executing these queries on precomputed tables, the server avoids unnecessary recalculation during each user interaction. This design reduces latency for explanation generation and provides a technical improvement in responsiveness.
The server constructs a generation prompt sentence for a generative AI model using a dedicated prompt construction module. The processor combines the retrieved financial information, the calculated indicators, and configuration rules stored in the storage device. The configuration rules specify, for example, that a beginner-level explanation should include explicit formulas, step-by-step numerical examples, and plain language descriptions, whereas an advanced-level explanation should emphasize interpretation and caveats. The server inserts explicit instruction information into the generation prompt sentence, such as:
“Explain the valuation ratio defined as price divided by earnings per share. Use the following data: [instrument identifier], current price, earnings per share, and computed ratio. Provide a step-by-step numerical example and a brief interpretation suitable for a beginner. Output in structured paragraphs with headings and bullet points.”
The server uses a generative AI model implemented as a neural network. In one embodiment, the server communicates with a remote generative AI service that provides a transformer-based neural network model trained on large-scale text data. The transformer model includes multiple layers of self-attention and feed-forward sublayers, with parameters (weights) learned by minimizing a language modeling loss function. During inference, the server supplies the generation prompt sentence as a token sequence. The model processes the token sequence layer by layer, using the learned weights and attention mechanisms to predict subsequent tokens of the explanation text. The server controls the model behavior by specifying decoding parameters, such as a temperature parameter and a maximum token count, which affect the diversity and length of the generated explanation.
The server executes additional control over the generative AI model by embedding structured numerical data and explicit constraints into the generation prompt sentence. For example, the server provides exact values for the current price, earnings per share, and computed valuation ratio, and instructs the model to use these values directly. This technique constrains the model's output and reduces the chance of generating inconsistent numbers. As a result, the server improves the technical accuracy of the generated explanations and reduces the need for post-generation correction.
The server receives the explanation text output by the generative AI model and performs formatting processing and numerical-example insertion processing. The processor parses the returned text to identify placeholders or locations where explicit numbers should be inserted. The server then substitutes actual computed indicator values into these positions. The server may also modify headings, insert list markers, and normalize the text into a structure that can be directly rendered by the terminal without additional client-side processing. This server-side formatting reduces computation at the terminal and ensures that different terminals with varying capabilities can display consistent content.
The server generates visualization data from the stored financial information and computed indicators. The processor selects time-series data corresponding to the concept explained in the text, such as historical valuation ratios for an instrument over a selected period. The server also collects category data, such as cash flows classified by type. The server encodes the data into structured records, including arrays of timestamps and corresponding values, as well as labels and metadata needed for chart rendering. The server stores this structured data in a format that can be interpreted by a visualization component running on the terminal. By generating visualization data in the same processing flow as the textual explanation, the server ensures that the textual and graphical information are synchronized and consistent.

The terminal receives the explanation information and the visualization data from the server. The terminal renders the text in a display area and uses a local graphics library to draw charts and tables. For example, the terminal displays a line chart of historical valuation ratios and a bar chart comparing different cash flow categories. The terminal associates user interface controls with the charts, such as tooltips that show precise values when the user hovers or taps on specific data points. Because the server has pre-structured the visualization data, the terminal can render complex graphs with minimal processing overhead.
The server also supports audio output by providing the explanation text as text information for audio output. The terminal sends the text information to a speech synthesis engine, such as a text-to-speech component provided by the operating system of the terminal or a remote speech synthesis service. The terminal converts the explanation text into an audio signal and plays the audio signal through speakers or headphones. The terminal collects operation information from the user, such as play, pause, and replay commands, as well as evaluation information indicating whether the audio output was understandable or too fast. The terminal transmits this information back to the server.
The server collects evaluation information and additional prompt sentences provided by the user after viewing or listening to the explanation. The server stores the evaluation information in the storage device, together with identifiers that link the evaluation to the corresponding generation prompt sentence and explanation output. The server analyzes the stored evaluation information using a feedback analysis module. In one embodiment, the server computes metrics such as average evaluation scores for different types of explanations, or correlation between explanation length and evaluation score. The server updates configuration rules for prompt construction based on these metrics. For example, if users frequently indicate that explanations are difficult to understand, the server adjusts the rules to reduce technical terminology and increase the number of step-by-step numerical examples. By modifying the configuration rules stored in the storage device, the server alters the construction of future generation prompt sentences, thereby altering the behavior of the generative AI model without retraining the model itself.
The server thus implements a feedback-driven adaptation mechanism that operates at the prompt construction level. This approach differs from conventional human-centric editing of explanations, because the server automatically transforms statistical patterns in evaluation information into changes in structured instruction information. As a result, the computer itself changes the way it uses the generative AI model over time, leading to a technical effect of reducing repetitive user clarification requests and improving average response quality without increasing processing time.
The server can employ different neural network configurations and training methods for the generative AI model. In one variant, the server accesses a generative model trained using supervised fine-tuning on domain-specific financial texts, where the training process minimizes a cross-entropy loss between the model outputs and reference explanations. In another variant, the server uses a reinforcement learning step in which model outputs are ranked automatically based on heuristic scoring that considers data-consistency with stored financial information. The server may use a ranking loss function to further adjust model parameters so that outputs with higher consistency scores are more likely to be produced. These training methods allow the generative AI model to better follow the structured instruction information and reduce inconsistencies, thereby improving technical reliability.

The server can use additional non-conventional rules when constructing generation prompt sentences to enforce data consistency. For instance, the server can attach a machine-readable summary of financial values, including checksums of particular rows or aggregated values, within the generation prompt sentence. The server can instruct the generative AI model to restate these values in the explanation. After receiving the explanation, the server can verify that the stated values match the original ones and, if discrepancies are detected, the server can either regenerate the explanation with stricter instructions or reject the response. This rule-based verification and regeneration loop is implemented programmatically and operates at machine speed, reducing the risk of erroneous outputs while minimally involving human supervision.
The server improves computational efficiency and reduces communication load by caching intermediate results. When the server receives a series of related prompt sentences from the same user, such as:
“Please explain how to calculate PER.”
“Now show me how PER has changed for the same company over the last five years.” the server reuses previously retrieved and computed indicator data, avoiding redundant access to the external information processing apparatus. The server maintains a session-level cache keyed by user and instrument identifiers, storing recent financial indicators and visualization data. When a related prompt sentence is detected, the server retrieves data from the cache, thereby decreasing network traffic and computation time. This caching strategy yields a technical effect of reducing latency and communication load on the network and external services.
The server can be implemented in multiple alternative configurations. In one configuration, the server executes all natural language processing and prompt construction modules locally and communicates with an external generative AI service only for model inference. In another configuration, the server hosts an on-premise generative AI model implemented on dedicated hardware, such as a graphics processing unit. In that case, the server executes both model inference and auxiliary processing within a local network, reducing external communication and improving control over latency and data privacy.
The server can also adopt different data storage architectures. In one embodiment, the server uses a relational database for structured financial information and a document-oriented data store for user evaluation logs and prompt construction rules. The server implements a data access layer that automatically routes read and write operations to the appropriate storage backend. This separation allows the server to optimize query performance for frequently accessed financial indicators while still maintaining flexible storage for semi-structured logs and configuration data.
The system offers technical advantages over conventional financial explanation tools. Because the server computes financial indicators once and reuses them across multiple explanation generations, the server reduces redundant numerical operations and lowers processor load. Because the server extracts structured attributes from prompt sentences and uses them to directly index financial data tables, the server avoids generic keyword searches and realizes faster, more precise retrieval. Because the server systematically constructs generation prompt sentences with explicit numerical constraints and formatting directives, the generative AI model produces explanations that require less post-processing and are more aligned with the stored financial information. Because the server updates configuration rules based on user evaluation information, the system continuously adjusts its computational behavior and reduces the frequency of unsatisfactory outputs. These effects collectively improve processing speed, accuracy, data management, and communication efficiency in a way that is not merely an automation of human interpretation, but an optimization of how computer resources are orchestrated.
In summary, the server, the terminal, and the user cooperate in a system that uses a generative AI model and structured prompt sentences to generate consistent, data-grounded financial explanations. The server manages specialized data structures for financial information and indicators, performs technical natural language processing operations, constructs and validates generation prompt sentences with numerical constraints, generates synchronized textual and visual outputs, and dynamically adjusts internal control rules based on machine-readable user evaluation information. Through these technical configurations, the system achieves improvements in computational efficiency, accuracy, and robustness that extend beyond simple computerization of human financial explanation tasks.

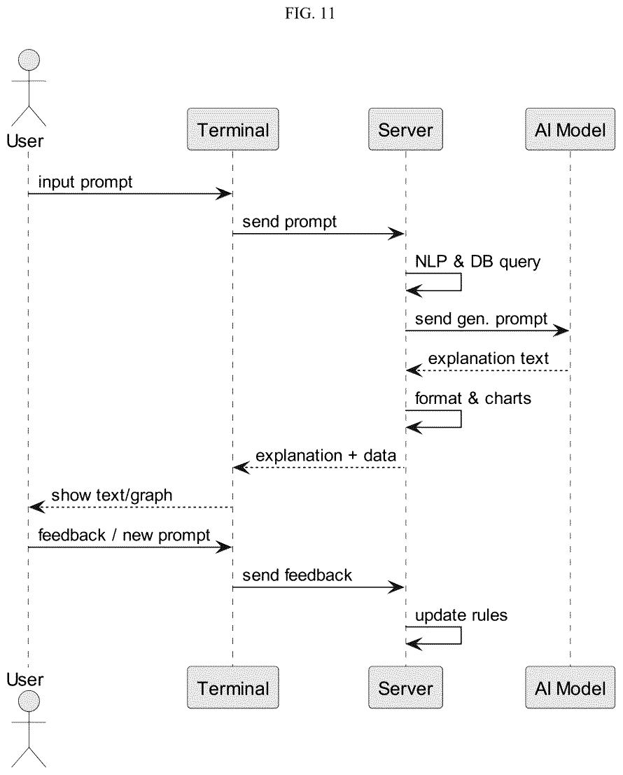

The following describes the processing flow using FIG. 11.
Step 1:
Server acquires and updates financial information.
Server receives, as input, configuration data including target financial instruments, data sources, and update intervals. Server sends data requests through the communication interface to an external information processing apparatus and receives, as input data, structured financial information such as prices and statement items. Server parses this input, converts textual and numeric fields into internal data structures, and performs data validation and normalization. Server writes, as output, normalized records and precomputed financial indicators into the storage device, thereby updating tables or collections that will be used in later steps.
Step 2:
Terminal initializes and displays a user interface.
Terminal receives, as input, interface definition data from the server or from a local application package. Terminal renders, as output, a graphical user interface including a text input field for a prompt sentence, selector controls for instruments and periods, and display areas for text explanations and charts. Terminal activates event handlers so that user operations on input controls generate structured user input data for transmission to the server.
Step 3:
User enters and submits a prompt sentence.
User receives, as input, the graphical user interface displayed on the terminal. User operates a keyboard, touch panel, or pointing device to type a prompt sentence in natural language, optionally selects a financial instrument and a time period, and triggers a send operation. User causes the terminal to output, to the server, a request containing the prompt sentence and selected parameters.
Step 4:
Terminal transmits user input to the server.
Terminal receives, as input, the prompt sentence and parameter values generated by the user's interaction. Terminal serializes this input into a request message, attaches metadata such as user identifiers or session identifiers, and sends, as output, the serialized data through the network interface to the server using a communication protocol.
Step 5:
Server logs and validates the user request.
Server receives, as input, the request message containing the prompt sentence and associated parameters. Server decodes the message, verifies that mandatory fields such as the prompt sentence and language setting are present, and checks basic constraints such as maximum length. Server writes, as output, a log entry including a request identifier, timestamp, and raw prompt sentence into a logging store, and passes a validated request object to subsequent processing modules.
Step 6:
Server performs natural language preprocessing of the prompt sentence.
Server receives, as input, the validated prompt sentence and any associated parameters. Server applies a natural language processing pipeline that performs tokenization, part-of-speech tagging, and syntactic parsing, generating structured representations of terms and dependency relations. Server uses pattern rules and term dictionaries to identify financial concept terms, time expressions, and instrument names. Server outputs, to a query preparation module, a set of extracted attributes, including concept identifiers, time ranges, and instrument identifiers.
Step 7:
Server retrieves relevant financial data from the storage device.
Server receives, as input, the extracted attributes from the natural language preprocessing and internal configuration rules specifying which data fields to retrieve for each concept type. Server constructs parameterized queries using the attributes, applies indices over instrument and time fields, and executes the queries against the storage device. Server aggregates, as needed, raw data into summary statistics or time-series, performing arithmetic operations such as sums, means, differences, and ratios. Server outputs, to a prompt construction module, a structured dataset containing financial information and precomputed indicators associated with the user's prompt sentence.
Step 8:
Server constructs a generation prompt sentence for the generative AI model.
Server receives, as input, the structured dataset and extracted attributes, together with configuration rules that define explanation style and detail level. Server composes a generation prompt sentence by embedding the retrieved numerical values, identified financial concepts, and explicit instruction information into a natural language template. Server adjusts the content of the prompt sentence according to user level and evaluation-history rules, for example choosing to include more step-by-step instructions when previous evaluations indicated insufficient clarity. Server outputs a finalized generation prompt sentence as text to a model inference module.
Step 9:
Server invokes the generative AI model and generates explanation text.
Server receives, as input, the generation prompt sentence and model control parameters such as maximum output length and randomness level. Server tokenizes the prompt sentence into a sequence of token identifiers and transmits this sequence, along with control parameters, to the generative AI model through the communication interface or an internal model invocation function. Server receives, as input from the model, a sequence of output tokens representing an explanation text. Server decodes the tokens back into natural language text and outputs, to a post-processing module, an explanation text that logically responds to the generation prompt sentence.
Step 10:
Server post-processes the explanation text and inserts numerical examples.
Server receives, as input, the raw explanation text from the generative AI model and the structured dataset of financial indicators. Server parses the explanation text to locate positions where numerical values or formulas are referenced, and cross-checks these positions against the structured dataset. Server replaces placeholders or generic numeric descriptions with actual numeric values from the dataset and normalizes the format of formulas, headings, and lists. Server outputs, as explanation information, a formatted text document that explicitly includes concrete numerical examples consistent with stored financial data.
Step 11:
Server generates visualization data corresponding to the explanation.
Server receives, as input, the explanation information and the structured dataset of financial information and indicators. Server selects appropriate variables, such as historical ratios or categorized cash flows, and converts these into ordered pairs of category or time values and numeric values. Server organizes these data into structured arrays or records representing labels, data points, and series identifiers needed for graphical rendering. Server outputs, to a response assembly module, visualization data that is synchronized with the explanation content.
Step 12:
Server assembles and sends a response to the terminal.
Server receives, as input, the explanation information and the visualization data. Server encapsulates both into a response message, optionally including identifiers for logging and subsequent feedback tracking. Server sends, as output, the response message through the communication interface to the terminal, thereby completing a cycle of explanation generation for the given prompt sentence.
Step 13:
Terminal renders textual and graphical output.
Terminal receives, as input, the response message containing explanation information and visualization data. Terminal parses the message, extracts text and data arrays, and invokes local rendering components. Terminal displays, as output to the user, the formatted explanation text in a scrolling area and draws graphs or tables using the visualization data, such as line charts for time-series indicators and bar charts for category-based values. Terminal updates the user interface to reflect the newly available content.
Step 14:
Terminal optionally generates and plays audio output.
Terminal receives, as input, the explanation text and a user command to enable audio.
Terminal passes the explanation text to a speech synthesis component, which converts the text into an audio signal by applying a text-to-phoneme conversion and waveform generation process. Terminal outputs the audio signal through an audio output device and displays audio control elements. Terminal also collects user operation events such as play, pause, and replay as control information.
Step 15:
User evaluates the explanation and optionally issues follow-up prompt sentences.
User receives, as input, the textual, graphical, and optionally audio outputs presented by the terminal. User inspects the explanation, listens to the audio if desired, and interacts with graphic elements, such as viewing specific data points. User then operates evaluation controls to provide feedback, for example selecting a rating or entering a short comment, and may enter a follow-up prompt sentence requesting additional details or different comparisons. User causes the terminal to output this evaluation information and any follow-up prompt sentence to the server.
Step 16:
Terminal sends evaluation information and follow-up prompts to the server.
Terminal receives, as input, the evaluation values, comments, and follow-up prompt sentence entered by the user. Terminal adds identifiers linking the feedback to the original response, serializes this information, and transmits, as output, a feedback message and an optional new request message through the communication interface to the server.
Step 17:
Server stores feedback and updates configuration rules.
Server receives, as input, the feedback message and any follow-up prompt sentence. Server writes the evaluation data into the storage device, associating it with the corresponding request and response identifiers. Server analyzes accumulated feedback, using statistical computations such as averages and distributions across explanation types, to evaluate explanation performance. Server updates, as output, configuration rules for prompt construction and model instruction content in the storage device, such as adjusting preferred explanation length or detail level for specific concepts. These updated rules are used as input for future executions of Step 8, thereby altering subsequent generation prompt sentences and improving overall system behavior over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented financial advisory systems typically separate numerical analysis of user financial data from natural language interactions with the user. In many existing systems, a server merely retrieves static financial records from a storage device and returns template-based responses, or invokes a generative AI model with only the raw user question and unstructured financial data. As a result, the computational resources of the server and the generative AI model are not efficiently utilized, the generated advice tends to be generic and inconsistent, and the system cannot systematically produce explanations that are tightly aligned with the user's actual financial patterns.
Furthermore, in known architectures, a natural language processing engine may parse user questions, and a database engine may perform numerical aggregation, but these components are loosely coupled and do not share a unified intermediate representation. This leads to duplicated processing, increased latency, and difficulties in maintaining deterministic control over the content and structure of AI-generated outputs. In practice, the server often passes large volumes of raw data to the generative AI model, forcing the generative AI model to perform data selection and structuring tasks that are better handled by conventional deterministic computation. This degrades scalability and wastes compute cycles on both the server and the model side.
In addition, many systems do not expose structured reduction candidates or optimization targets as machine-readable data associated with the generated advice. Instead, potential expenditure reductions, priority categories, and target ratios are embedded implicitly in text, which prevents downstream components from programmatically visualizing or re-using these results. Consequently, user terminals cannot efficiently render interactive user interfaces, such as category-based reduction dashboards, without re-parsing or re-computing information from the natural language output, resulting in redundant computation and a brittle overall system design.
Moreover, conventional prompt construction methods do not modularize numerical indicators and condition information, such as target expenditure reduction rates, saving goals, or investment policies. These values are typically encoded ad hoc in free-form text, which makes it difficult for the server to systematically control the behavior of the generative AI model, to enforce constraints, or to evolve the system configuration without retraining or manual prompt rewriting. This ad hoc approach creates technical challenges in optimizing model usage, improving response consistency, and supporting real-time, large-scale user traffic.
Accordingly, there is a need for an improved computer-implemented financial advisory system and server-side processing method that: (i) programmatically integrates numerical aggregation, natural language understanding, and prompt construction into a unified processing pipeline; (ii) generates compact, structured prompt sentences that offload deterministic computation from the generative AI model to the server; (iii) attaches structured metadata representing expenditure classifications and reduction candidates to the generated advice; and (iv) parameterizes numerical indicators and conditions in a way that allows efficient and controllable interaction with a generative AI model. By addressing these issues at the system and processor configuration level, the invention aims to improve the functioning of the computer itself, including reduced processing redundancy, improved resource utilization, and more reliable, context-appropriate AI-generated financial guidance.

The specific processing by the specific processing unit 290 of the data processing device 12 in Application Example 1 is realized by the following means.

The present invention provides a server comprising a processor and an input/output device, the processor being configured to receive, via the input/output device, a natural language question and user identification information from a user terminal; to obtain, from a remote storage device, user transaction history information and income/expense information based on the user identification information, and convert the transaction history information and the income/expense information into financial status summary data including category-based expenditure amounts, period-based expenditure amounts, income amounts, and saving rates by performing aggregation processing and statistical processing; to apply a natural language processing program to the question to perform morphological analysis and semantic analysis, extract intent information and finance-related keywords from the question, and identify a financial support type based on the intent information; to generate a descriptive text including the financial status summary data, the financial support type, and the question, and configure a prompt sentence to be input to a generative artificial intelligence model by using the descriptive text, thereby instructing the generative artificial intelligence model to generate an explanation or advice regarding a specific financial concept; to receive the explanation or the advice output from the generative artificial intelligence model, perform post-processing including rounding of currency amounts and normalization of expression formats, and transmit the post-processed explanation or advice to the user terminal; and to add structured data including expenditure classification information and reduction-candidate classification information to the explanation or the advice and, as needed, numerical indicators and condition information including at least one of an expenditure reduction rate, a saving target, and an investment policy, and control presentation of the explanation or the advice and the structured data on the user terminal by causing them to be displayed as character information and, as needed, output as audio information using a speech synthesis program. This enables integration of deterministic financial computation and natural language understanding into a unified server-side pipeline, reduces redundant processing within the generative AI model, provides machine-readable optimization metadata alongside human-readable advice, and allows fine-grained, parameterized control over the behavior of the generative AI model, thereby improving the overall performance, scalability, and reliability of the computer-implemented financial advisory system.

The term “processor” refers to a hardware or virtual computation unit, such as a central processing unit or a processing core of an electronic computing apparatus, that executes instructions of a program to perform data processing operations described herein.
The term “input/output device” refers to a hardware or software interface component that enables transmission and reception of data between the server and external devices, including user terminals and storage devices, over wired or wireless communication networks.
The term “user terminal” refers to an information processing apparatus operated by an end user, such as a mobile communication device, a portable computing device, or a desktop computing device, which executes an application program to transmit questions and receive advice.
The term “natural language question” refers to character string data composed according to a human language, such as a spoken or written language, that expresses an inquiry from a user regarding a financial concept, financial status, or financial advice.
The term “user identification information” refers to data that uniquely or quasi-uniquely identifies a user or a user account within the system, such as an identifier, a token, or a credential, used to associate the user with corresponding financial data.
The term “remote storage device” refers to a data storage system accessible over a communication network, such as a database system or cloud storage system, that stores user transaction history information and income/expense information.
The term “transaction history information” refers to structured or semi-structured records of financial transactions associated with a user, including at least a transaction date, a transaction amount, and optionally a transaction category or description.
The term “income/expense information” refers to financial data representing inflows and outflows of monetary value for a user over time, including salary income, other income, fixed expenses, variable expenses, and other monetary movements.
The term “financial status summary data” refers to data generated by aggregation and statistical processing of raw financial records, including computed values such as category-based expenditure amounts, period-based expenditure amounts, income amounts, and saving rates.
The term “category-based expenditure amounts” refers to numerical values representing total expenditure for a user classified into expenditure categories, such as housing, food, utilities, entertainment, or other categories.
The term “period-based expenditure amounts” refers to numerical values representing total expenditure for a user aggregated for defined time periods, such as daily, weekly, monthly, or yearly periods.
The term “income amounts” refers to numerical values representing total monetary inflows for a user over a specified period, obtained by aggregating income-related transaction records.
The term “saving rates” refers to numerical indices representing a ratio between a user's savings and the user's income or expenses over a specified period, calculated using aggregated financial data.
The term “aggregation processing” refers to data processing operations that combine multiple financial records to compute summary values, such as totals, averages, or counts, grouped by category, period, or other criteria.
The term “statistical processing” refers to data processing operations that calculate numerical indices based on financial data, including measures such as sums, means, ratios, and other statistical metrics used to characterize a financial status.
The term “natural language processing program” refers to software that analyzes natural language text to determine linguistic structure and meaning, including at least tokenization, part-of-speech tagging, and semantic interpretation.
The term “morphological analysis” refers to processing of natural language text into constituent tokens and associated attributes, such as word forms, base forms, and grammatical roles.
The term “semantic analysis” refers to processing of natural language text to infer meaning, including identification of relationships between words, detection of intent, and extraction of semantic roles or entities.
The term “intent information” refers to data representing a logical purpose or goal expressed by a user in a natural language question, such as a request for expense reduction, saving planning, or investment guidance.
The term “finance-related keywords” refers to terms or phrases extracted from a natural language question that are associated with financial concepts, entities, or operations, such as spending, savings, investment, or risk.
The term “financial support type” refers to a classification label that specifies a category of financial assistance to be provided to a user, such as expense optimization, risk warning, saving planning, or investment recommendation.
The term “descriptive text” refers to a natural language text generated by the processor that combines summarized financial data, a financial support type, and a user question into a coherent textual description.
The term “prompt sentence” refers to a natural language instruction or request constructed by the processor for input to a generative artificial intelligence model, specifying context, constraints, and tasks for generating an explanation or advice.
The term “generative artificial intelligence model” refers to a machine learning model configured to generate natural language text or other content in response to an input prompt sentence, based on parameters learned from training data.
The term “specific financial concept” refers to a defined notion, rule, method, or principle in the financial domain, such as budgeting, diversification, emergency funds, or debt repayment strategy.
The term “explanation or advice” refers to natural language output generated for a user that describes, clarifies, or recommends actions regarding the user's financial situation or financial concepts.
The term “post-processing” refers to processing applied to output text from the generative artificial intelligence model, including at least formatting adjustments, numerical rounding, and normalization of expressions.
The term “rounding of currency amounts” refers to numerical processing of monetary values to adjust precision, such as rounding to a specified unit or number of digits, for presentation consistency.
The term “normalization of expression formats” refers to processing of textual content to conform to predetermined presentation rules, such as consistent use of currency symbols, decimal separators, or date formats.
The term “expenditure classification information” refers to data indicating the category assignments for expenditures within financial status summary data, such as mapping each expenditure to a predefined category.
The term “reduction-candidate classification information” refers to data indicating expenditure categories or items that are identified as candidates for reduction or optimization based on financial status summary data.
The term “structured data” refers to data organized according to a defined schema or format, such as key-value pairs, tables, or records, suitable for programmatic access and visualization.
The term “numerical indicators” refers to quantitative values used as parameters or targets in generating financial advice, such as percentages, thresholds, or absolute monetary values.
The term “condition information” refers to constraints or requirements associated with the generation of financial advice, including rules, bounds, or preferences related to savings, spending, or investment.
The term “expenditure reduction rate” refers to a numerical indicator representing a desired or recommended proportion by which a specific expenditure or set of expenditures should be reduced.
The term “saving target” refers to a numerical goal for accumulated savings over a specified period or up to a specified amount.
The term “investment policy” refers to a set of conditions or guidelines regarding allocation of financial resources into investment instruments, including risk preferences, time horizons, or diversification rules.
The term “speech synthesis program” refers to software configured to convert text data, such as explanation or advice text, into audio signals representing spoken language for playback on an output device.

In one embodiment, a server cooperates with one or more terminals to implement the financial advisory system. The server comprises at least one processor, a main memory, a network interface, and access to a remote storage device such as a relational database system implemented on a storage apparatus. The terminal comprises a processor, a display, an audio output device, an input device, and a wireless or wired communication interface. The terminal executes an application program implemented, for example, in a high-level language environment, and the server executes a server-side application implemented, for example, on an operating system running on a general-purpose computing platform.
The server stores user financial records in the remote storage device in the form of structured records. The server associates each record with a user identifier and fields such as transaction date, transaction amount, transaction category, transaction description, and income/expense flag. The server stores these records in database tables with indexed columns for user identifier, date, and category to enable efficient retrieval and aggregation. The server further stores configuration data defining expenditure categories and parameters for aggregation periods, such as current month, previous month, or rolling three-month window.
The server uses a software stack including a web application framework, a database driver, a numerical computation library, a data frame library, and a natural language processing library. The server loads a trained generative AI model into a model serving environment or accesses the generative AI model via an application programming interface. The generative AI model has a neural network architecture including multiple transformer layers, attention mechanisms, feed-forward layers, and learned weight parameters that have been trained on large corpora of text using a sequence-to-sequence or next-token prediction objective. The server stores configuration parameters for the generative AI model, including maximum token length, sampling temperature, and response format constraints.
The server maintains a natural language processing pipeline using a library that provides tokenization, part-of-speech tagging, dependency parsing, and named entity recognition. The server loads a language model that defines word embeddings, lexicon rules, and statistical parameters for the natural language processing tasks. The server uses this pipeline to extract intent information and finance-related keywords from user questions. The server maps extracted patterns to an internal taxonomy of financial support types, which includes, for example, expense optimization, saving goal planning, risk alert generation, and investment allocation guidance.
The server performs deterministic aggregation and statistical processing on financial data prior to interaction with the generative AI model. The server uses a data frame structure to hold retrieved transaction records for a given user and period. The server groups the records by expenditure category and by time period, and the server computes total amounts, averages, and ratios using numerical operations. The server derives financial status summary data including at least category-based expenditure amounts, period-based expenditure amounts, income amounts, and saving rates. The server stores these derived values in a compact intermediate data structure separate from the raw transaction records.
The server converts the intermediate data structure into a machine-interpretable and human-interpretable representation that is constrained in size and content. The server formats the summary data into controlled textual fragments, such as “Category: Food, Monthly total: 40,000 units, Ratio to total expenses: 15%.” The server combines these fragments with intent labels and finance-related keywords to construct a descriptive text. The server then converts the descriptive text into a prompt sentence for the generative AI model. The prompt sentence explicitly specifies the user profile, expenditure breakdown, and the analytic task to be performed by the generative AI model.
In one concrete example, the server constructs the following prompt sentence as a plain text string:
“You are a financial advisor powered by a generative AI model.
Analyze the following user financial data and generate clear, concrete advice on how the user can reduce their spending this month.
User profile:
Monthly income: 300,000 units
Average monthly spending: 280,000 units
Spending breakdown for the last 3 months:
   Housing: 100,000 units
   Food (groceries): 40,000 units
   Dining out: 50,000 units
   Utilities: 20,000 units
   Entertainment: 30,000 units
   Subscriptions: 10,000 units
   Other: 30,000 units
User question: ‘How can I reduce my spending this month?’
Task:
1. Identify which expense categories the user can realistically reduce in the next month.
2. Propose specific and actionable steps, such as reducing the frequency of dining out or canceling subscriptions.
3. Provide the advice in polite English, in two or three short paragraphs.”
The server transmits the prompt sentence to the generative AI model by invoking an inference interface. The generative AI model receives the prompt as a sequence of tokens and processes the tokens through its neural network layers. The model applies attention mechanisms to compute context-dependent representations and outputs a probability distribution over possible next tokens at each generation step. The model generates explanation or advice text token by token according to a decoding algorithm, such as greedy decoding or sampling with temperature. The server receives the generated output as a sequence of tokens and decodes it into a character string.
The server applies post-processing routines to the generated string. The server normalizes numerical expressions by detecting patterns representing monetary values and applying rounding rules to align with system settings, such as rounding to the nearest hundred or thousand. The server standardizes formatting of currency symbols, percent signs, and date expressions to match a consistent output format. The server filters content for prohibited patterns and adjusts text segments that violate system rules. The server optionally segments the advice into paragraphs and inserts headings or bullet markers for easier rendering by the terminal.
The server generates structured data in parallel with the textual advice. The server identifies, within the financial status summary data, expenditure categories that exceed predetermined thresholds, such as categories with ratios above a target ratio or categories with month-over-month growth above a target growth rate. The server marks these categories as reduction candidates and encodes them into a structured representation containing fields such as category name, current amount, target amount, and recommended reduction rate. The server associates this structured data with the generated advice by attaching identifiers or tags.
The server further adds numerical indicators and condition information to subsequent prompt sentences when refinement or additional advice is required. The server computes an expenditure reduction rate based on a savings target specified by the user or determined by system rules. The server calculates, for example, that a 10% reduction in dining out and a 5% reduction in entertainment achieve a specified monthly savings goal. The server then constructs a prompt sentence that includes explicit numerical targets and constraints, such as “Assume the user wants to save an additional 20,000 units this month. Recommend how to allocate reductions across the categories marked as reduction candidates while maintaining essential expenses.” The server thus uses numerical indicators and condition information not merely as displayed results but as control parameters for the generative AI model.
The terminal presents the explanation or advice and the associated structured data to the user. The terminal receives response data from the server through a communication interface. The terminal decodes the data, renders the advice text on a graphical user interface, and displays visual indications of expenditure categories, such as bar charts or labeled lists, highlighting reduction candidates. The terminal also uses a speech synthesis program to convert the advice text into audio, which is played through the terminal's speaker or a connected audio device. The terminal controls the timing, volume, and language settings of the audio output using the operating system's media APIs.
The user interacts with the system by reading or listening to the advice and by entering additional questions or confirming suggested reduction rates. The user may, for example, indicate that a proposed reduction is infeasible, and the terminal transmits this feedback to the server. The server then updates internal parameters and constructs a new prompt sentence that includes the feedback as an explicit condition, such as “Do not reduce housing expenses, and avoid suggesting reductions in essential medical expenses. Recompute a reduction plan using the remaining categories.”
The server improves computer technology by shifting deterministic numerical computation and aggregation from the generative AI model to the server's structured data pipeline. The server reduces the token length and complexity of the prompt sentences by pre-computing summary statistics and by encoding only essential information required by the generative AI model. This architecture reduces network bandwidth usage between the server and the model endpoint, lowers computational load on the generative AI model, and improves response latency. The server also improves accuracy and stability of the generated advice by constraining the model context to consistent, pre-processed summaries rather than raw transaction logs.
The server uses a specific data flow that includes: retrieval of raw financial records from the remote storage device, transformation into data frame structures, execution of grouping and aggregation operations, generation of intermediate feature vectors representing category ratios and volatility measures, mapping of these feature vectors to financial support types, and synthesis of a compact descriptive text. The server thereby defines a non-conventional combination of traditional data processing and neural language generation. The server's construction of prompt sentences based on structured intermediate data represents a technical process that optimizes generative AI resource usage and improves determinism compared to approaches that directly pass raw data into the model.
The generative AI model is not used as a black box performing unspecified reasoning. The server defines, for the generative AI model, specific roles and boundaries. The server uses the model solely for natural language generation conditioned on already computed numerical features and explicit constraints. The server defines for the model a fixed architecture of transformer layers with defined numbers of attention heads, hidden dimensions, and activation functions. The server trains or fine-tunes the model using supervised learning on pairs of financial profiles and expert-written advice. During training, the server defines a loss function, such as cross-entropy over token sequences, and uses gradient descent with backpropagation to update weight parameters. The server applies regularization techniques and data augmentation, such as paraphrasing and scenario diversification, to improve generalization and robustness.
The server implements a rule-based layer outside the generative AI model to enforce non-conventional processing procedures. The server applies filtering rules to prevent the model from suggesting actions that violate regulatory or safety constraints. The server enforces numeric consistency rules by comparing generated values with computed summary data and rejecting or correcting outputs that deviate beyond predetermined error thresholds. The server thus uses the generative AI model in combination with deterministic rule-based control to achieve high precision in financial advice generation.
The system provides multiple alternative embodiments. In one embodiment, the server executes the generative AI model locally on the same hardware platform that executes the web application framework. In another embodiment, the server accesses the generative AI model hosted on a separate computational cluster, and the server uses a dedicated communication protocol to transmit prompt sentences and receive responses. In yet another embodiment, the terminal executes a lightweight version of the natural language processing program to perform preliminary analysis of the user question and to reduce the amount of text transmitted to the server.
The terminal configuration also allows variations. In one embodiment, the terminal is a mobile communication device with a touch screen and an integrated microphone, and the terminal converts user speech into text before sending the question to the server. In another embodiment, the terminal is a desktop device or a kiosk system in a financial institution, and the terminal displays additional visualization layers such as interactive sliders for adjusting expenditure reduction rates.
The described architecture yields technical effects beyond mere automation of human financial advice. The server reduces redundant computation by preventing the generative AI model from performing aggregation or database querying tasks and instead supplies the model with pre-aggregated data. This separation of concerns leads to faster response times, more predictable resource consumption, and improved scalability for a large number of users. The server also improves accuracy and reduces error by constraining model outputs via rule-based normalization and numeric consistency checks, which are not typically feasible in manual processes. The system thus improves the functioning of the computer system itself by optimizing data flow, reducing communication overhead, and enhancing reliability of AI-assisted financial guidance.

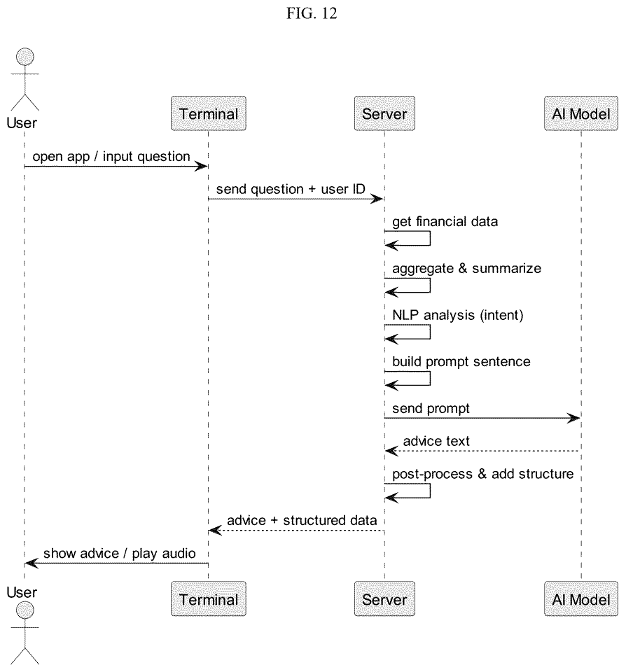

The following describes the processing flow using FIG. 12.
Step 1:
The user operates the terminal to start a financial advisory application. The terminal displays a question input screen and accepts a natural language question and implicit or explicit user identification information. The input in this step is user interaction events (touch or keyboard input) and an application-stored user identifier; the output is a UTF-8 question string and a user identifier stored in the terminal's application memory. The terminal concatenates the user identifier and the question into an internal data structure in preparation for transmission.
Step 2:
The terminal constructs a request message for the server. The input is the question string and the user identifier obtained in Step 1; the output is a serialized request, for example an HTTP request body, containing the question and the user identifier. The terminal performs data conversion from internal objects to a text-based representation and sets communication headers such as content type and authentication tokens. The terminal then transmits the request through a communication interface to the server.
Step 3:
The server receives the request from the terminal through a network interface. The input is the serialized request transmitted in Step 2; the output is an internal representation of the request containing the user identifier and the question text. The server parses the request format, validates the presence of mandatory fields, and discards malformed or unauthorized requests. The server records a timestamp and associates it with the request for logging and later correlation with responses.
Step 4:
The server acquires user financial records from a remote storage device. The input is the user identifier extracted in Step 3; the output is a set of raw financial records associated with the user. The server constructs and executes one or more queries to retrieve transaction history and income/expense records, filtering by user identifier and by target period, such as the current month or a rolling window. The server converts the raw records from the storage device into an in-memory table or list of records, each including a date, an amount, a category, and an income/expense flag.
Step 5:
The server transforms the raw financial records into financial status summary data. The input is the in-memory table of financial records from Step 4; the output is a structured summary including category-based expenditure amounts, period-based expenditure amounts, income amounts, and saving rates. The server groups the records by category and period, sums amounts within each group, and computes ratios of category totals to overall expenses. The server further calculates income totals and a saving rate by subtracting total expenses from total income and dividing by income. The server stores these results in an intermediate data structure optimized for further processing.
Step 6:
The server applies a natural language processing program to the question text. The input is the question string obtained in Step 3; the output is an analyzed representation containing tokens, grammatical labels, and semantic features. The server performs tokenization to split the question into words or sub-words, assigns part-of-speech tags, and constructs a dependency tree to identify syntactic relations. The server then extracts entities and key phrases that relate to financial concepts, such as “reduce spending this month” or “emergency fund,” and stores them as candidate features.
Step 7:
The server determines the user's intent and financial support type based on the analyzed question. The input is the semantic features and key phrases generated in Step 6; the output is an intent label and a financial support type. The server compares the extracted features with pre-defined patterns and classification rules, such as checking for reduction verbs, time expressions, and monetary terms. The server may also apply a classifier that maps feature vectors to categories like expense optimization or saving planning. The server then assigns the most appropriate financial support type and holds it for subsequent processing.
Step 8:
The server combines the financial status summary data and the intent information into a descriptive text. The input is the summary data from Step 5 and the financial support type and key phrases from Step 7; the output is a descriptive text that explains the user's current financial situation in controlled language. The server formats each summary element into short sentences, such as “Your dining-out expenses average 50,000 units per month, which is 18% of your total expenses,” and organizes them by category and importance. The server appends a description of the user's goal inferred from the intent, such as “The user intends to reduce overall spending this month.”
Step 9:
The server constructs a prompt sentence for the generative AI model. The input is the descriptive text from Step 8 and the original user question from Step 3; the output is a single prompt sentence or a prompt text block to be provided to the generative AI model. The server concatenates the user profile, the summarized expenditure information, the user question, and a task specification that instructs the model to generate explanation or advice regarding a specific financial concept. The server explicitly defines constraints such as the desired style, length, and focus categories in the prompt sentence to reduce ambiguity. The server thereby prepares a structured context that directs the generative AI model to use the pre-computed numerical information instead of inferring it independently.
Step 10:
The server optionally enriches the prompt sentence with numerical indicators and condition information. The input is the financial status summary data and any explicit targets specified by the user or by system policy; the output is an enhanced prompt sentence containing values such as expenditure reduction rates, saving targets, or investment policy parameters. The server computes, for example, that a certain combination of category reductions achieves a desired savings amount and encodes these values in the prompt sentence. The server then finalizes the prompt text by embedding these indicators as explicit instructions, such as “Recommend a plan that reduces dining-out expenses by 10% and entertainment expenses by 5% while preserving essential expenditures.”
Step 11:
The server sends the prompt sentence to the generative AI model and receives generated text. The input is the finalized prompt sentence created in Step 9 and Step 10; the output is a generated explanation or advice text. The server tokenizes the prompt for the model interface, sets inference parameters such as maximum token length and sampling temperature, and transmits the token sequence to the model. The generative AI model processes the tokens through its neural network layers and returns a sequence of output tokens. The server decodes the tokens back into a character string representing the explanation or advice.
Step 12:
The server post-processes the generated explanation or advice text. The input is the raw generated text from Step 11 and the financial status summary data from Step 5; the output is a normalized and policy-compliant advice text. The server scans the text to identify monetary amounts and adjusts them to align with computed values, correcting any discrepancies that exceed a predefined tolerance. The server applies rounding rules to numeric expressions and standardizes currency symbols and formats. The server removes redundant phrases and organizes the text into paragraphs or bullet points, improving readability and conformity with system guidelines.
Step 13:
The server generates structured data representing expenditure classifications and reduction candidates. The input is the financial status summary data and, where applicable, the numerical indicators used in Step 10; the output is a set of structured records linked to the generated advice. The server selects categories whose expenditures exceed thresholds or whose reduction yields significant savings, marks them as reduction candidates, and computes recommended reduction rates or target amounts. The server encodes this information as structured records with fields such as category identifier, current amount, target amount, and recommended reduction rate. The server associates identifiers linking these records to the corresponding textual advice.
Step 14:
The server returns the advice text and the structured data to the terminal. The input is the post-processed advice text from Step 12 and the structured data from Step 13; the output is a response message ready for transmission to the terminal. The server constructs a response structure that includes the advice text, the list of reduction candidate categories, and any additional metadata such as timestamps and model version identifiers. The server serializes this structure into a transmission format and sends it to the terminal through the communication interface.
Step 15:
The terminal receives and decodes the response from the server. The input is the response message transmitted in Step 14; the output is an internal representation containing the advice text and the structured data. The terminal verifies the integrity of the message, parses the transmitted format, and extracts the advice and category information. The terminal stores this data in memory for display and interaction. The terminal may also prepare additional UI elements, such as charts or sliders, based on the structured data fields.
Step 16:
The terminal presents the advice text and visual indicators of reduction candidates to the user. The input is the advice text and structured data stored in Step 15; the output is a rendered user interface showing readable text and graphical elements. The terminal arranges the text in readable paragraphs and displays category names and corresponding amounts in a list or chart. The terminal highlights recommended reduction categories using color or icons and displays suggested reduction rates or target amounts. The terminal thereby converts the structured data into a human-perceivable representation.
Step 17:
The terminal optionally generates audio output for the advice. The input is the advice text from Step 15 and user settings that enable voice playback; the output is audio signals emitted by the terminal's speaker or connected audio device. The terminal passes the text to a speech synthesis program, receives audio data as a result, and sends the audio data to a media playback component. The terminal controls volume and playback timing according to system settings and user actions, thus allowing the user to receive the advice without reading the screen.
Step 18:
The user reviews the advice and may provide feedback or follow-up questions through the terminal. The input is the displayed or spoken advice and interactive UI elements; the output is new user interaction data such as modified targets, confirmations, or additional questions. The user may adjust suggested reduction percentages or reject certain category recommendations. The terminal captures these inputs and stores them as updated parameters or new question strings, which can be transmitted to the server in subsequent iterations. This feedback enables the server to construct new prompt sentences that incorporate user constraints and to refine advice in later processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information-provision systems that answer user questions in natural language typically treat a user query as a monolithic text string and directly submit it to a general-purpose generative model or retrieve loosely related documents using simple keyword matching. Such architectures often fail to accurately identify the user's true intent, do not systematically structure domain knowledge before generation, and do not adapt the generation behavior of the model based on explicit, machine-interpretable control signals. As a result, these systems frequently produce responses that are either overly generic, inconsistent in depth, or misaligned with the user's requested explanation style, thereby limiting their usefulness for tasks requiring precise and domain-specific explanations, such as explanations of financial concepts.
Furthermore, in many existing systems, the interaction between the application logic, the retrieval component, and the generative model is weakly coupled: the application logic does not construct a structured intermediary representation of the retrieved information, and the generative model is not provided with explicit control parameters (for example, intent type, detail level, explanation style) encoded in a prompt sentence. This loose coupling leads to inefficient use of computational resources, because the generative model must implicitly infer both the task and the desired output characteristics from raw text, and it increases the likelihood of generating redundant, unfocused, or excessively long responses.
In addition, conventional systems often lack a systematic feedback mechanism at the system level. They do not log, in a structured manner, the relationships between user questions, constructed prompts, and generated explanations, nor do they use such logs to refine prompt-generation rules and the contents of the knowledge store over time. Consequently, the system cannot effectively adapt to observed failures or performance bottlenecks, and the quality and consistency of generated explanations stagnate rather than improve as more interactions occur.
From a computer-technology perspective, these limitations manifest as suboptimal utilization of processing resources in the server and the terminal, inefficient orchestration of natural language processing components, and inadequate control over the generative model's behavior. There is a need for a technical solution that restructures the end-to-end processing pipeline spanning question acquisition at the terminal, intent and keyword extraction at the server, structured knowledge retrieval, prompt sentence construction with explicit control parameters, and logging-driven refinement so that the computer system can more reliably produce accurate, concise, and context-appropriate explanations while improving throughput and scalability.
Accordingly, an object of the present invention is to provide a system and server-side processing architecture that (i) automatically converts raw user question data into a structured representation including intent information and keyword information, (ii) retrieves and organizes domain knowledge into structured information prior to generation, (iii) constructs a prompt sentence embedding both the structured information and explicit control parameters for the generative AI model, and (iv) records detailed processing logs for adaptive refinement. By solving these technical problems, the invention improves the functioning of the underlying computer system itself, including improved control of data flows between modules, more predictable generation behavior, and more efficient use of computational resources.

The specific processing by the specific processing unit 290 of the data processing device 12 in Example 2 is realized by the following means.

The present invention provides a server comprising a processor configured to receive, via a communication interface, question data expressed in natural language from a terminal, to perform preprocessing on the question data by means of a natural language processing algorithm in order to extract intent information and keyword information, to access a knowledge information storage device based on the keyword information so as to search and acquire concept information and example information related to the question data, to generate structured information including at least a portion of the concept information and the example information, to construct a prompt sentence including the structured information, the question data, and control parameters comprising at least intent type information, detail level information, and explanation style information, to input the prompt sentence to a generative artificial intelligence model, to analyze a token sequence output from the generative artificial intelligence model in order to generate explanation text, to transmit response data including the explanation text to the terminal, and to store, in a recording device, processing log information corresponding to at least the question data, the prompt sentence, and the explanation text, and to update, based on the processing log information, generation rules for the prompt sentence and stored contents of the knowledge information storage device. This enables the computer system to more efficiently and reliably generate domain-specific explanations by tightly integrating natural language analysis, structured knowledge retrieval, and controlled prompt construction, to improve the precision, consistency, and responsiveness of explanation generation by the generative artificial intelligence model, and to adaptively refine system behavior over time through systematic logging and update of internal control and knowledge structures.

The term “system” refers to a combination of at least one terminal, at least one server, and at least one storage device, which cooperate via a communication network to execute the processing described in the claims.
The term “processor” refers to a hardware computation unit, such as a central processing unit or a graphics processing unit, that executes program instructions to perform logical operations, data processing, and control of other components.
The term “terminal” refers to an information processing apparatus operated by a user, such as a computing device including an input/output device and a communication interface, which is configured to transmit question data to a server and to present response data to the user.
The term “server” refers to an information processing apparatus including at least one processor and a communication interface, which is configured to receive question data from a terminal, perform analysis and retrieval processing, cooperate with a generative artificial intelligence model, and transmit response data to the terminal.
The term “input/output device” refers to a component of the terminal configured to receive input data from a user and to output information to the user, and includes at least one input device such as a keyboard or touch panel and at least one output device such as a display or speaker.
The term “communication network” refers to a wired or wireless data communication infrastructure, such as a local area network or a wide area network, through which the terminal and the server exchange data.
The term “question data” refers to digital data representing a user's inquiry, expressed in natural language, which is transmitted from the terminal to the server for analysis and response generation.
The term “natural language” refers to a human language, such as a spoken or written language used in daily communication, as distinguished from a formal programming language or a machine language.
The term “natural language processing algorithm” refers to a software-implemented procedure for processing natural language text, including at least one of tokenization, part-of-speech tagging, syntactic analysis, semantic analysis, intent classification, and keyword extraction.
The term “intent information” refers to data indicating a type or purpose of a user's question, such as a request for a definition, a request for a detailed explanation, a request for a comparison, or another categorized objective.
The term “keyword information” refers to data representing one or more important terms or phrases extracted from question data, which serve as search conditions or identifiers for retrieving related information from a storage device.
The term “knowledge information storage device” refers to a storage resource, such as a memory or a database system, configured to store structured or semi-structured information including concept information, example information, and related metadata.
The term “concept information” refers to stored data describing an abstract or domain-specific notion, including at least one of a name, a definition, a formula, a property, or a usage associated with the notion.
The term “example information” refers to stored data representing concrete instances, scenarios, or use cases that illustrate a corresponding concept, including explanatory text, numerical examples, or application cases.
The term “structured information” refers to data organized according to a predefined schema or format, such as a record, a list, or a tree structure, that includes at least concept information and example information related to a user's question.
The term “prompt sentence” refers to a sequence of symbols including text that is constructed to instruct a generative artificial intelligence model, and that includes at least a portion of question data, structured information, and optionally one or more control parameters.
The term “generative artificial intelligence model” refers to a trained computational model that receives an input including a prompt sentence and outputs a sequence of symbols representing generated content, such as an explanation text, based on learned statistical relationships.
The term “token sequence” refers to an ordered list of discrete units, such as subword units, words, or symbols, produced by or input to a natural language model, which collectively represent text data.
The term “explanation text” refers to natural language text generated in response to question data, which is intended to provide an answer, clarification, or explanation, and which is transmitted from the server to the terminal.
The term “response data” refers to digital data transmitted from the server to the terminal and including at least explanation text, and optionally including additional metadata such as identifiers or status information.
The term “display device” refers to an output component of a terminal that visually presents information to a user, such as a liquid crystal display, an organic light emitting display, or another visual display apparatus.
The term “control parameters” refers to data items used to influence behavior of a generative artificial intelligence model, including at least one of intent type information, detail level information, and explanation style information.
The term “intent type information” refers to a control parameter that indicates a classification of the user's objective, such as a request for a brief definition, a detailed explanation, a step-by-step description, or another categorized intent.
The term “detail level information” refers to a control parameter that indicates a desired degree of depth or granularity of content in the explanation text, such as a summary level, an intermediate level, or a highly detailed level.
The term “explanation style information” refers to a control parameter that indicates a desired manner of presentation of the explanation text, such as an educational style, a technical style, a concise style, or a narrative style.
The term “processing log information” refers to data stored for record-keeping and analysis, including at least associations among question data, a corresponding prompt sentence, generated explanation text, timestamps, and processing metadata.
The term “recording device” refers to a storage component, such as a non-volatile memory or a database system, configured to store processing log information and other persistent data used by the server.
The term “generation rules” refers to one or more algorithms, templates, or configuration data sets that specify how a prompt sentence is to be constructed from question data, structured information, control parameters, and other contextual information.
The term “stored contents of the knowledge information storage device” refers to the information items, such as concept information, example information, and associated metadata, that are maintained within the knowledge information storage device and are subject to update based on processing log information.

In one embodiment, a server, a terminal, and a communication network cooperatively implement the invention. The server includes at least one processor, a main memory, a non-volatile recording device, a communication interface, and a knowledge information storage device implemented, for example, as a relational database system. The server executes application software including a natural language processing module, a prompt-construction module, a generative AI model interface module, and a logging and adaptation module. The terminal includes at least one processor, a memory, a display device, and an input/output device such as a touch panel and a microphone, and executes a user interface application implemented as a web application or a native application.
The user operates the terminal to input question data expressed in natural language. The user, for example, enters a question such as “Please explain free cash flow in detail.” into a text field displayed on the display device of the terminal and activates a send control. The terminal controls the input/output device to acquire the question data and to display a visual indication that the question has been accepted. The terminal converts the question data into a character string encoded in a character code such as UTF-8 and generates a message including the question data and metadata such as a user identifier and a time stamp. The terminal then uses a communication protocol stack to transmit the message to the server over the communication network.
The server receives the message via the communication interface and stores the received question data temporarily in a buffer region of the main memory. The server executes the natural language processing module to perform preprocessing on the question data. In one embodiment, the natural language processing module uses a tokenization algorithm that splits the character string into tokens according to a subword scheme such as byte-pair encoding. The server converts the tokens into integer indices according to a vocabulary table stored in the memory. The server then applies a statistical or neural intent classification model to the token sequence to derive intent information indicating, for example, that the question is a “detailed explanation request” for a financial concept.
The server further executes a keyword extraction algorithm to derive keyword information from the question data. The server, for example, uses a combination of part-of-speech tagging and noun phrase chunking to extract candidate phrases, and applies a weighting scheme such as term frequency inverse document frequency to select important terms. When the question includes “free cash flow”, the keyword extraction algorithm outputs keyword information including at least the phrase “free cash flow” and a generic term such as “financial indicator.” The server represents each keyword as a string and optionally as a numerical vector generated by a sentence-embedding model.
The server accesses the knowledge information storage device to retrieve concept information and example information corresponding to the keyword information. The server issues a data access instruction to a database engine that maintains tables storing concept information as records with fields such as concept_name, definition, formula, and usage, and example information as records with fields such as example_text and example_context. The server uses at least one of exact matching on a concept_name field and similarity-based retrieval using vector indexes to acquire records whose concept_name or description fields match or are similar to the keywords. For the keyword “free cash flow”, the server acquires a concept record that includes a definition of free cash flow, a formula such as “operating cash flow minus capital expenditures,” and one or more example records illustrating how free cash flow is used in evaluating a business entity.
The server then generates structured information from the retrieved concept information and example information. The server constructs a hierarchical data structure in memory, such as a tree or a graph, where a root node represents the main concept and child nodes represent definition, formula, usage, and multiple examples. Each node stores a text field and metadata such as a priority or relevance score. The server orders the child nodes according to the relevance score so that the most important aspects of the concept are placed earlier. By standardizing the structure in this way, the server reduces redundancy and ensures that subsequent processing by the generative AI model can focus on normalized, machine-prepared content instead of raw database records.
The server generates a prompt sentence to be input to a generative AI model. The server concatenates multiple segments including: (i) a role description instructing the model how to behave, (ii) a reproduction of the question data, (iii) a textual rendering of the structured information, and (iv) control parameters indicating an expected intent type, desired detail level, and explanation style. The control parameters are inserted as explicit textual markers so that the generative AI model can interpret them as instructions rather than as content to be explained. An example of such a prompt sentence is:
You are a financial education assistant.
User intent: detailed_explanation
Detail level: high
Explanation style: beginner_friendly
The user asked: “Please explain free cash flow in detail.”
Here is structured information from the knowledge base:
Concept: Free Cash Flow
Definition: Cash generated by a business entity after accounting for cash outflows required to support operations and maintain capital assets.
Formula: Free Cash Flow=Operating Cash Flow−Capital Expenditures.
Usage: Indicates how much cash is available for distributions, debt repayment, equity repurchases, and new investments.
Example: When a company has a high free cash flow, it has more flexibility to pay dividends or invest in new projects without raising external funds.
Based on the above, explain free cash flow in clear and concrete language suitable for a beginner.
The server executes the generative AI model interface module to supply the prompt sentence to a generative AI model implemented, for example, as a transformer-based neural network stored in the server or in a connected computing apparatus. In one embodiment, the generative AI model includes an embedding layer, a plurality of transformer blocks, and an output projection layer. Each transformer block includes a multi-head self-attention mechanism and a position-wise feedforward network. The model includes millions or billions of parameters stored as weight matrices and bias vectors in a memory space accessible by a graphics processing unit.
The server converts the prompt sentence into token indices using the same vocabulary as the generative AI model. The server then transfers the token indices to a graphics processing unit, where the generative AI model executes numerical operations such as matrix multiplication, scaling, and nonlinear activation to produce contextualized vector representations for each token. The attention mechanism computes attention scores between tokens using dot products and softmax normalization, allowing the model to weigh different parts of the prompt sentence according to relevance. The output layer generates, for each time step, a probability distribution over the vocabulary, and the server selects or samples the most probable tokens sequentially to form a token sequence representing explanation text.
The server thus obtains a token sequence as an output of the generative AI model and decodes the token sequence back into a character string representing explanation text. The server may apply post-processing rules such as truncating the explanation at a sentence boundary when a maximum length is reached, normalizing spacing, and removing undesired control tokens. The server packages the explanation text into response data along with metadata such as latency measures and model configuration identifiers, and transmits the response data to the terminal via the communication network.
The terminal receives the response data and extracts the explanation text. The terminal then controls the display device to present the explanation text to the user in a readable layout. For example, the terminal displays headings for definition, formula, and usage, and uses line breaks and font styling to distinguish content segments. The user reads the explanation text and may choose to input a follow-up question, which is processed in the same manner. In another embodiment, the server further generates and applies control parameters to achieve improved technical performance. The server, for example, analyzes historical processing log information stored in the recording device, including pairs of question data and explanation text, to adjust a mapping between intent types and numerical values such as maximum token counts or temperature parameters used by the generative AI model. By constraining the generative AI model with tailored control parameters per intent type and per concept category, the server reduces unnecessary token generation, thereby decreasing inference time and communication load between the server and the terminal. This yields a concrete improvement in processing speed and resource utilization compared with a configuration in which the same static prompts and parameters are used for all questions.
The server stores processing log information in the recording device, where each log record links question data, the corresponding prompt sentence, explanation text, time stamps for each processing phase, and quality indicators such as user feedback or internal consistency checks. The server periodically executes the logging and adaptation module to analyze this data. The server, for example, applies a clustering algorithm to group similar questions and identifies which prompt sentence templates and which sets of control parameters produced explanation text with shorter generation times and higher quality scores. The server updates generation rules for prompt construction by modifying, adding, or removing template segments and control parameter values stored in configuration data. The server also updates stored contents of the knowledge information storage device by inserting additional examples or refining definitions where gaps or ambiguities were identified in the log analysis. These adaptive updates enable the system to evolve its internal behavior with respect to both prompt construction and knowledge retrieval, resulting in improved accuracy and robustness of explanation generation over time.
From a technical perspective, the combination of structured information generation and explicit control parameter embedding in the prompt sentence produces a specific improvement in the functioning of the computer system. Without structured information, the generative AI model would be required to infer a concept structure from raw text, resulting in higher internal computational complexity and potentially longer inference sequences. By providing a pre-normalized, relevance-ordered structure, the server reduces the need for the model to allocate attention across irrelevant or redundant content, thereby concentrating computational effort on salient concept components. This reduction in effective input entropy leads to faster convergence of the model's decoding process and a reduction in redundant token generation, which can be observed as decreased latency and lower average token counts per answer.
In addition, the use of explicit control parameters representing intent type, detail level, and explanation style allows the server to treat the generative AI model as a controllable computing component rather than a black-box text generator. The server applies rule-based logic to derive these parameters from question data and structured information, and encodes them in a machine-readable form within the prompt sentence. This rule-based parameterization is not a mere automation of human judgment but a non-conventional control scheme that constrains the internal operation of the generative AI model in a way that a human could not realize manually in real time. As a result, the generated explanation text exhibits more consistent length, more stable terminology, and more predictable structure, which in turn simplifies downstream processing and caching strategies in the server, further enhancing performance.
In an alternative embodiment, the server implements the generative AI model as a locally hosted neural network that can be trained or fine-tuned on domain-specific data. The server stores training data sets in the recording device and periodically executes a training procedure. During training, the server divides each prompt sentence and explanation text pair into input and target token sequences and computes a loss value using a cross-entropy loss function between predicted token distributions and target tokens. The server updates the model's parameters by applying a gradient-based optimization algorithm such as stochastic gradient descent or an adaptive optimizer. The training process is distributed across multiple processing units, and intermediate gradient values are aggregated via a communication bus or high-speed interconnect. This training procedure allows the server to adjust the generative AI model to better respect the control parameters and the structure of the knowledge base, thereby improving the alignment between prompt sentences and outputs.
In a further embodiment, the server uses separate neural components for intent classification, keyword extraction, and explanation generation. The server may implement the intent classification model as a smaller transformer network or a recurrent neural network that is optimized for classification tasks, while the generative AI model is optimized for sequence generation. This modular configuration allows the server to execute the intent classification and keyword extraction with lower latency and to reserve heavy computational resources for explanation generation only when needed. By distributing processing in this way, the server reduces overall energy consumption and increases throughput of questions per unit time, providing a measurable technical advantage over monolithic approaches.
The system is not limited to financial concepts. The server can store concept information and example information for other specialized domains such as medicine, engineering, or law. The structured information generation and prompt construction mechanisms remain the same; only the content of the knowledge information storage device and the domain-specific templates for prompt sentences are modified. The server may select different explanation styles and detail levels depending on the domain, using the same control parameters but different mapping rules. For example, in a medical domain, the server may generate prompts instructing the generative AI model to present information with explicit disclaimers and simplified terminology for non-expert users.
By combining domain-specific knowledge retrieval, structured information generation, explicit control parameter embedding, and logging-based adaptation, the server and terminal together implement a computer-implemented system that operates according to a specific, non-conventional architecture. The server improves data management by normalizing and structuring retrieved information, improves calculation efficiency by reducing unnecessary model computations through targeted prompts and control parameters, reduces communication load by controlling output length, and enhances accuracy by adaptively refining prompts and knowledge contents. Consequently, the invention provides more than an abstract idea of answering questions; it provides a concrete improvement to the way computers analyze natural language queries, control generative AI models, and manage internal knowledge and logs to deliver technically enhanced performance.

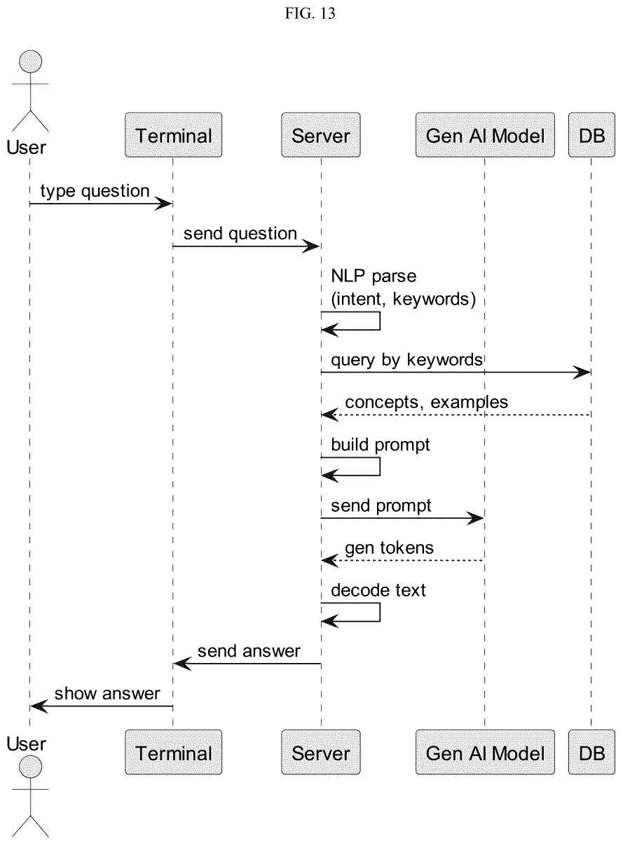

The following describes the processing flow using FIG. 13.
Step 1:
The user operates the terminal to input question data. The user views a text input field on the display device of the terminal, enters a natural-language question such as “Please explain free cash flow in detail.”, and activates a send control (for example, a button or a keyboard command). The input of this step is the user's keystrokes and touch events, and the output is a completed text string representing the question. The terminal converts the individual input events into a continuous character string using an input method editor, applies character encoding (for example, UTF-8), and stores the resulting question string in a memory buffer for subsequent transmission.
Step 2:
The terminal generates a request message including the question data and transmits the request message to the server. The input of this step is the question string stored in the terminal's memory. The terminal constructs a data structure containing at least the question string, a user identifier, and a time stamp, and serializes this structure into a text-based message format such as JSON. The terminal then invokes a networking library to open a connection over a communication network and encapsulates the serialized message into one or more protocol packets (for example, HTTP over TLS). The output of this step is a sequence of network packets transmitted from the terminal toward the server.
Step 3:
The server receives the request message and extracts the question data. The input of this step is the sequence of network packets arriving at the server via a communication interface. The server's network stack reassembles the packets into a complete message, verifies integrity using checksums and security protocols, and passes the message payload to an application process. The server then deserializes the payload from the message format into an internal data object and reads the field that stores the question string. The output of this step is the question string and associated metadata stored in the server's main memory.
Step 4:
The server preprocesses the question data using a natural language processing algorithm. The input of this step is the question string obtained in Step 3. The server converts the question string to a normalized form by applying operations such as lowercasing (if language-appropriate), trimming whitespace, and normalizing Unicode code points. The server then tokenizes the text into a sequence of tokens using a tokenization procedure (for example, whitespace and punctuation splitting or a subword segmentation algorithm). The server may remove stop words and perform lemmatization to reduce inflected forms to base forms. The output of this step is a token sequence and a normalized question string stored in the server's memory.
Step 5:
The server derives intent information from the token sequence. The input of this step is the token sequence generated in Step 4. The server converts each token into an integer index according to a vocabulary table and forms a fixed-length or variable-length vector representation for the entire sequence. The server then inputs this representation to an intent classification model, such as a neural network or another statistical classifier, which computes class scores for predefined intent categories (for example, “definition”, “detailed explanation”, “comparison”). The server selects the category with the highest score as intent information. The output of this step is a data item indicating the detected intent type associated with the question.
Step 6:
The server extracts keyword information from the preprocessed question. The input of this step is the normalized question string and the token sequence. The server executes a keyword extraction algorithm that includes part-of-speech tagging and phrase chunking to identify noun phrases and technical terms. The server may compute term weight values using a scheme such as term frequency inverse document frequency and select terms with weights above a threshold. For example, from the question “Please explain free cash flow in detail.”, the server selects “free cash flow” and “financial indicator” as keyword candidates. The output of this step is a list of keywords and, optionally, numerical embeddings for these keywords.
Step 7:
The server retrieves concept information and example information from a knowledge information storage device. The input of this step is the list of keywords generated in Step 6. The server constructs query expressions, such as SQL statements or key-value lookups, that match the keywords to stored fields such as concept names, aliases, or descriptions. The server sends the queries to a database engine, which searches indexed tables for records corresponding to the keywords. The database engine returns records that contain concept fields (definition, formula, usage) and example fields (example_text, example_context). The server receives these records and parses them into internal structures. The output of this step is a collection of concept information and example information objects related to the user's question.
Step 8:
The server generates structured information from the retrieved concept and example data. The input of this step is the collection of concept information and example information obtained in Step 7. The server organizes these objects into a hierarchical or tabular structure, assigning roles such as “main concept,” “definition,” “formula,” “usage,” and “example.” The server may compute relevance scores based on keyword overlap and field-specific weights, and sort the elements according to these scores. The server then constructs a structured representation, such as a tree-like data structure in memory, that associates each text segment with its role and relevance. The output of this step is structured information that provides an organized, machine-readable summary of the domain knowledge for the question.
Step 9:
The server derives control parameters for the generative AI model. The input of this step is the intent information from Step 5 and the structured information from Step 8. The server applies rule-based logic or a learned mapping to determine control parameter values, including at least an intent type label, a detail level indicator, and an explanation style indicator. For example, if the intent is “detailed explanation” and the concept is tagged as “basic financial term,” the server may select a high detail level and a beginner-friendly explanation style. The server encodes these parameters as text labels or key-value pairs that can be embedded into a prompt sentence. The output of this step is a set of control parameters associated with the question.
Step 10:
The server constructs a prompt sentence for a generative AI model. The input of this step is the normalized question string, the structured information, and the control parameters. The server concatenates fixed template segments with variable fields to generate an instruction text that includes: (i) a description of the model's role, (ii) an explicit representation of the control parameters, (iii) the original question, and (iv) a textual version of the structured information. The server formats this text with line breaks and labels to separate sections clearly. The output of this step is a complete prompt sentence ready to be supplied to the generative AI model.
Step 11:
The server converts the prompt sentence into token indices for input to the generative AI model. The input of this step is the prompt sentence generated in Step 10. The server applies a tokenizer consistent with the generative AI model's vocabulary to segment the prompt sentence into tokens, and then maps each token to a corresponding integer index using a vocabulary table. The server stores the sequence of indices in a contiguous region of memory and may pad or truncate the sequence to satisfy model length requirements. The output of this step is a numerical token sequence representing the prompt sentence.
Step 12:
The server executes the generative AI model to generate a token sequence representing explanation text. The input of this step is the token sequence from Step 11. The server transfers the token sequence to a computation device, such as a graphics processing unit, and invokes the generative AI model, which typically includes an embedding layer, multiple transformer blocks, and an output projection layer. The model converts token indices into embedding vectors, applies attention and feedforward operations repeatedly across layers, and produces a sequence of output probability distributions over the vocabulary. The server uses decoding logic, such as greedy decoding or sampling with temperature and top-p settings, to select output tokens step by step until an end condition is met. The output of this step is an output token sequence corresponding to the generated explanation.
Step 13:
The server decodes the generated token sequence into human-readable explanation text and performs post-processing. The input of this step is the output token sequence from Step 12. The server maps each token index back to its text representation using the vocabulary table and concatenates the token texts into a continuous character string. The server removes special tokens, normalizes whitespace, and may truncate the text at a sentence boundary if a maximum length is exceeded. The server can also apply formatting rules, such as inserting headings derived from the structured information. The output of this step is a finalized explanation text string stored in the server's memory.
Step 14:
The server generates response data including the explanation text and transmits the response data to the terminal. The input of this step is the explanation text obtained in Step 13 and metadata such as processing time and model identifiers. The server constructs a response object containing at least the explanation text and serializes this object into a transmission format, such as a text-based structured format. The server then instructs its networking stack to encapsulate the serialized payload into one or more response packets and sends these packets over the communication network to the terminal. The output of this step is a sequence of outbound packets carrying the response data.
Step 15:
The terminal receives the response data and extracts the explanation text. The input of this step is the sequence of response packets arriving at the terminal. The terminal's communication interface and protocol stack reassemble the packets, verify integrity, and pass the payload to the user interface application. The terminal deserializes the payload into an internal data structure and reads the field that stores the explanation text. The output of this step is the explanation text string stored in the terminal's memory and ready for presentation.
Step 16:
The terminal presents the explanation text to the user via the display device. The input of this step is the explanation text obtained in Step 15. The terminal updates its graphical user interface by creating or modifying a text display component, setting its content to the explanation text, and adjusting layout properties such as font size, line spacing, and scrolling position. The terminal sends rendering commands to the display subsystem, which draws the text onto the screen. The output of this step is a visual representation of the explanation text on the display device, which the user can read and interpret.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In interactive information systems that answer user inquiries regarding technical or financial concepts, conventional architectures typically perform a simple pipeline: a user query is received, a static search is executed against a data repository, and a fixed template answer is returned. Such systems suffer from several technical limitations.
First, the processing pipeline does not tightly integrate natural language understanding, structured data retrieval, numerical computation, and generative text production. In many existing systems, natural language processing, database access, and text generation are implemented as loosely coupled components, often in separate services, with minimal shared context. This fragmentation causes inefficiencies in data handling, increased latency due to multiple network round-trips and transformations, and difficulty in maintaining consistency between the data actually used for computation and the explanation presented to the user.
Second, conventional systems typically generate responses without explicit control over the internal text-generation process. For example, a generic generative model may be invoked with a minimal prompt that does not explicitly encode structured computation results, user attributes, or presentation constraints. As a result, the generated response may omit key computed indicators, may not reflect the latest data retrieved from external sources, or may fail to comply with interface constraints such as length, sectioning, or severity indication. This degrades the reliability and predictability of the system's behavior and complicates verification and debugging.
Third, existing interactive systems rarely incorporate emotion-aware processing in a technically structured way. While some user interfaces may adapt colors or icons based on coarse sentiment, the underlying architectures do not treat emotion estimation as an input signal that systematically controls prompt construction and generative behavior. Emotion recognition, when present, is often an ad hoc add-on at the presentation layer and is not consistently propagated into the computational core. As a result, the system cannot reliably modulate explanation tone, detail level, and warning intensity according to a recognized emotional state, nor can it guarantee consistent behavior across different channels and sessions.
Fourth, conventional systems do not effectively integrate user-or entity-specific transactional and asset data into a unified numerical processing stage that directly drives generative warning messages. In many implementations, risk evaluation is separated from the explanation generation engine, and the generative component does not receive structured, machine-interpretable risk-related data. This separation leads to duplicated logic, inconsistent risk messaging, and excessive engineering effort to synchronize rule-based warnings with generative text.
These limitations arise from architectural and data-flow constraints in the computing systems themselves, including the way processors manage heterogeneous inputs (natural language, structured data, emotion signals), orchestrate external services (databases, emotion engines, generative models), and construct intermediate representations (prompt sentences, explanation data, risk-related data). There is thus a need for a computer-implemented system that improves the technical processing pipeline by: (i) unifying natural language parsing, data retrieval, and numerical analysis within a single processor workflow; (ii) constructing structured prompt sentences that explicitly encode computation results, user attributes, and presentation constraints for a generative model; (iii) using emotion estimation as a first-class control signal that systematically modifies prompt construction and output post-processing; and (iv) integrating transaction and asset data into a numerical processing stage that programmatically generates risk-related data and corresponding warning messages via a generative model.

The specific processing by the specific processing unit 290 of the data processing device 12 in Application Example 2 is realized by the following means.

The present invention provides a server comprising a processor configured to receive inquiry information from a user terminal, analyze the inquiry information using a natural language processing technique to identify a target concept and a target object, acquire related information including definition information, numerical information, and historical information from at least one data storage apparatus or external information providing apparatus based on the identified target concept and target object, integrate the related information and perform numerical processing including calculation of index values, calculation of statistical values, and risk evaluation so as to generate explanation data, generate a structured prompt sentence including explanation content, warning content, and expression conditions based on the explanation data, the inquiry information, and user attribute information, provide the prompt sentence as input to a generative AI model and obtain explanation information and warning information from the generative AI model, and construct output data including the explanation information and the warning information together with classification information and importance information and transmit the output data to the user terminal; the processor being further configured to generate emotion information indicating a user emotional state by performing emotion estimation processing based on at least one of audio information, image information, and the inquiry information acquired from the user terminal, adjust at least one of a writing style, a level of detail, and an expression intensity of at least one of the prompt sentence, the explanation information, and the warning information in accordance with the emotion information, and cause the user terminal to present adjusted explanation information and adjusted warning information; and the processor being further configured to acquire transaction information and asset information relating to at least one of the user and a transaction counterpart, evaluate budget impact, spending tendency, and future risk in the numerical processing by using the transaction information and the asset information to generate risk-related data including an evaluation result, generate a prompt sentence that instructs generation of a warning message regarding at least one of a financial risk and a transaction risk based on the risk-related data, provide the prompt sentence to the generative AI model, and cause the user terminal to present the warning message obtained from the generative AI model. This enables a technically improved, integrated processing pipeline in which a single processor orchestrates natural language analysis, structured data retrieval, numerical computation, emotion-aware control of prompt construction, and generative response production, thereby reducing latency and inconsistency, ensuring that generated explanations and warnings are tightly coupled to computed data and recognized user emotion, and enhancing the reliability, adaptability, and efficiency of computer-based interactive information services.

The term “processor” refers to a hardware-implemented information processing element, such as a central processing unit or other computation circuitry, that executes instructions to perform the functions described in this specification.
The term “system” refers to an arrangement including at least one processor and one or more storage and communication components configured to cooperate in order to execute the processing described in this specification.
The term “user terminal” refers to an information processing device including at least a display device and an input device, such as a portable terminal, a stationary terminal, or a communication terminal, which exchanges data with the system and allows a user to submit inquiries and receive output data.
The term “display device” refers to a presentation component, such as a screen or other visual output unit, that displays information to a user.
The term “input device” refers to a user interface component, such as a keyboard, pointing device, touch panel, or microphone, that acquires operation information or inquiry information from a user.
The term “inquiry information” refers to information representing a user's question or request, expressed in natural language text, voice, or other user input, and used as input to analysis processing by the processor.
The term “natural language processing technique” refers to a procedure or algorithm executed by the processor to analyze natural language text, including at least one of tokenization, part-of-speech tagging, syntactic analysis, semantic analysis, and entity extraction.
The term “target concept” refers to a subject matter concept, such as a technical concept, a financial concept, or another domain concept, that is identified from the inquiry information and that is to be explained or evaluated.
The term “target object” refers to an entity referenced in the inquiry information, such as an organization, an account, or another identifiable subject, that is associated with the target concept.
The term “related information” refers to information obtained from at least one information storage device or external information providing device and including at least one of definition information, numerical information, and historical information relevant to the target concept and the target object.
The term “information storage device” refers to a storage unit, such as a database apparatus or a memory apparatus, that stores related information or other data used in the processing described in this specification.
The term “external information providing device” refers to a server, service, or other information source external to the system that provides data such as reference information, numerical data, or historical records in response to a request from the processor.
The term “definition information” refers to descriptive information representing a definition, explanation, or description of a concept, term, or indicator.
The term “numerical information” refers to quantitative values, such as measurement values, indicator values, or computed values, that can be processed as numeric data.
The term “historical information” refers to time-series information or past records associated with the target concept or the target object, such as past indicator values, past events, or past transactions.
The term “numerical processing” refers to processing performed by the processor on numerical information, including at least one of calculation of index values, calculation of statistical values, transformation of data, and evaluation of risk.
The term “index value” refers to a numerical indicator derived from one or more underlying numerical values, representing a characteristic such as performance, stability, or risk.
The term “statistical value” refers to a numerical value obtained through statistical computation, such as an average, variance, distribution parameter, or correlation measure.
The term “risk evaluation” refers to a computation process that estimates a likelihood or severity of a potential adverse condition, using at least one of numerical information, historical information, and model-based analysis.
The term “explanation data” refers to structured data generated by the processor as an intermediate representation of content to be explained, including computation results and contextual information to be used for generating natural language output.
The term “user attribute information” refers to information associated with a user, such as profile information, preference information, knowledge level, or usage history, that influences generation of explanation content or presentation conditions.
The term “prompt sentence” refers to a text string or similar structured input that is provided to a generative AI model and that includes instructions, context, and data to control generation of explanation information or warning information.
The term “expression conditions” refers to constraints or specifications embedded in or associated with a prompt sentence, such as target tone, length, level of detail, language style, or formatting requirements, for controlling generated content.
The term “generative AI model” refers to a machine-learned information processing model that generates text or other output data in response to an input prompt sentence, based on parameters obtained through training on example data.
The term “explanation information” refers to natural language text or equivalent content generated or obtained through processing, which describes the target concept or explains data to the user.
The term “warning information” refers to natural language text or equivalent content generated or obtained through processing, which notifies the user of a potential adverse condition, risk, or caution.
The term “classification information” refers to metadata indicating a category or type of generated content, such as distinguishing between explanation content, warning content, and advice content.
The term “importance information” refers to metadata indicating a degree of importance, priority, or severity associated with explanation information or warning information.
The term “output data” refers to a data structure constructed by the processor for delivery to the user terminal and including at least one of explanation information, warning information, classification information, and importance information.
The term “emotion estimation processing” refers to processing that detects or estimates a user's emotional state based on at least one of audio information, image information, and inquiry information.
The term “emotion information” refers to data indicating an estimated emotional state of a user, such as categories or scores representing conditions like anxiety, frustration, neutrality, or confidence.
The term “writing style” refers to a characteristic of text expression, such as politeness level, directness, complexity, or formality, applied to explanation information or warning information.
The term “level of detail” refers to a degree of granularity or depth in explanation information or warning information, such as the amount of technical detail or number of examples provided.
The term “expression intensity” refers to a strength or emphasis level in the phrasing of explanation information or warning information, such as how strongly a risk or recommendation is expressed.
The term “transaction information” refers to data describing one or more transactions related to a user or a transaction counterpart, including at least elements such as amounts, dates, counterpart identifiers, and categories.
The term “asset information” refers to data describing assets or financial positions of a user or a transaction counterpart, including at least holdings, balances, and valuations.
The term “budget impact” refers to an effect of at least one transaction on a planned or target budget, as computed in numerical processing.
The term “spending tendency” refers to a pattern or trend of expenditures over time, such as changes in frequency, amount, or category distribution of spending.
The term “future risk” refers to a predicted likelihood or potential magnitude of an adverse financial or transactional condition occurring in a future period.
The term “risk-related data” refers to data generated by the processor that represents evaluation results of budget impact, spending tendency, and future risk, and that is used as input for generation of warning messages.
The term “transaction counterpart” refers to another entity involved in a transaction with the user, such as another organization, account, or party.
The term “warning message” refers to text or equivalent output generated based on risk-related data, which conveys information about at least one of a financial risk and a transaction risk to the user.

In one embodiment, a server implements the claimed system using one or more physical processors, a main memory, a non-volatile storage device, and a communication interface connected to a data network. The server executes an operating system, such as a general-purpose server operating system, and an application stack including a web server component, an application framework, and a set of software modules that perform natural language processing, numerical computation, emotion estimation, and interaction with a generative AI model. A terminal operates as a user-facing computing device that includes a display device, an input device, a microphone, and optionally a camera. The terminal executes a native or web-based client application that communicates with the server over a secure communication channel, such as HTTPS.
The server implements a natural language processing module using a software library such as spaCy running in an execution environment provided by a programming language runtime. The server implements a numerical computation module using a data analysis library such as Pandas, in combination with a numerical library such as NumPy. The server implements a machine learning and risk evaluation module using a library such as a gradient boosting framework or a logistic regression framework provided by a machine learning toolkit. The server communicates with a generative AI model by calling an external application programming interface exposed by a generative AI service or by executing a local neural network implemented, for example, using a deep learning framework.
The server stores related information in at least one data storage device, such as a relational database system. The relational database stores records of financial concepts, indicator definitions, user attributes, transaction histories, and entity-level financial data. The database organizes the data into normalized tables with indexes for fast lookup by concept identifier, entity identifier, and time interval. The server uses this structured storage to obtain definition information, numerical information, and historical information in a consistent and low-latency manner, thereby reducing redundant data transfer and post-processing.
The server analyzes inquiry information received from the terminal by applying tokenization, part-of-speech tagging, and named-entity recognition using the natural language processing module. The server constructs an internal data structure that represents the inquiry as a graph or mapping containing elements such as a target concept, a target object, temporal modifiers, and question type. The server maps identified entities to canonical identifiers in the database. By performing this mapping with a deterministic algorithm and by maintaining a mapping table, the server reduces ambiguity that would otherwise cause inconsistent retrieval results. The server acquires related information from the database system by generating structured queries that retrieve definition records, time-series indicator records, and transactional records associated with the target concept and the target object. The server joins multiple tables into a consolidated data set that includes, for example, balance sheet values, income statement values, cash-flow values, and user-level budget values. The server stores this data set as a DataFrame object in the numerical computation module. The DataFrame object contains named columns corresponding to financial attributes and indexed rows corresponding to time points. The server derives additional features, such as rolling averages, volatility measures, and ratios, by applying vectorized operations over the DataFrame. This reduces the computational complexity compared to iterative row-by-row processing and improves cache locality, thereby reducing processing time.
The server performs numerical processing by computing index values and statistical values with respect to the retrieved data. The server computes ratios such as liquidity ratio and equity ratio by applying element-wise division across DataFrame columns. The server computes statistical values such as mean, standard deviation, and quantiles using aggregation functions of the numerical library. The server evaluates risk by applying a trained risk evaluation model. In one embodiment, the risk evaluation model comprises a gradient boosted decision tree ensemble trained on historical financial data labeled with default events or significant adverse outcomes. The server extracts a feature vector from the DataFrame for each entity, including features such as leverage ratio, cash-flow trend slope, earnings volatility, and coverage ratios. The server inputs this feature vector into the ensemble and obtains a scalar risk score representing probability of a predefined risk event. The server stores the numerical results in explanation data that includes both raw values and derived risk-related metrics.
The server generates a prompt sentence for a generative AI model by combining the explanation data, the original inquiry information, and user attribute information. The server stores an intermediate representation of the explanation data as text fragments associated with identifiers, such as “liquidity_ratio_text” or “equity_ratio_text.” The server constructs a prompt sentence template that includes placeholders for these fragments and for meta information such as target tone, level of detail, and language. The server fills the template with context-specific values. For example, the server may generate a prompt sentence of the following form:
“The user asks: ‘What is EBITDA?’. Use the following base definition: ‘EBITDA is operating profit plus depreciation and amortization and indicates a company's earning power.’ Generate a concise, clear explanation for a non-expert. Avoid technical jargon and keep the answer under 120 words.”
In another example, the server may generate a prompt sentence of the following form:
“The user is anxious and asks: ‘Is this company's financial position stable?’. Here are the latest financial indicators: liquidity ratio=1.8, equity ratio=35%, debt ratio=60%, free cash flow trend=decreasing, risk score=0.4. Explain the current financial stability in simple terms and mention any future risks. Use a calm, reassuring tone, and provide one practical suggestion.”
In yet another example, the server may generate a prompt sentence of the following form:
“The user asks: ‘Will this payment affect my budget?’. Emotion: worried. Monthly budget=300,000 units. Spending so far this month=220,000 units. New payment amount=40,000 units. Explain whether this payment is within the budget, highlight any risk, and give one concrete piece of advice. Use friendly and reassuring language.”
By encoding numerical results, user attributes, and presentation constraints directly in the prompt sentence, the server imposes an explicit structure on the input to the generative AI model. This structure causes the generative AI model to produce output that adheres to the data and constraints specified by the server and avoids unbounded free-form responses that may omit critical computed information. As a result, the system improves the reliability and traceability of generative outputs compared to conventional approaches that simply pass unstructured questions to a text generator.
The server obtains explanation information and warning information by transmitting the prompt sentence to a generative AI model. In one embodiment, the generative AI model is a neural network comprising multiple transformer layers, including self-attention layers and feed-forward layers with non-linear activation functions. The generative AI model is pre-trained on large corpora of text and optionally fine-tuned for the domain in question. The server communicates with the generative AI model by sending a request via an API, specifying the prompt sentence, the maximum number of tokens to generate, and sampling parameters such as temperature and top-k. The server receives a sequence of tokens from the generative AI model, decodes the tokens into text, and segments the output into explanation sections and warning sections based on markers included in the prompt or based on structural cues.
The server adjusts the generative behavior further by integrating emotion information obtained from emotion estimation processing. The terminal captures voice and optionally face images when the user provides the inquiry. The terminal compresses these media signals and sends them to the server or to an external emotion analysis service. The server applies an emotion estimation algorithm, such as a convolutional neural network on spectrogram features for voice and a convolutional or transformer-based model on face images for expressions. The server extracts features such as pitch contours, energy profiles, and facial action units and passes them to the emotion estimation model. The emotion estimation model computes emotion probabilities for classes such as “anxiety,” “anger,” and “neutrality.” The server converts these probabilities into an emotion label and a numerical intensity value.
The server uses the emotion label and intensity value to adjust at least one of the prompt sentence, the explanation information, and the warning information. For example, when the emotion label indicates anxiety, the server selects a template with a lower lexical complexity score and includes explicit reassurance phrases in the prompt sentence. When the emotion label indicates anger, the server increases the requirement for directness and specificity in the prompt sentence. By changing the prompt sentence based on computed emotion information, the system modifies the operation of the generative AI model in a manner that is not achievable by a human operator issuing ad hoc prompts. The system standardizes a mapping from emotion features to control tokens and constraints, thereby achieving consistent modulation of tone and detail.
The server constructs output data as a structured object that includes explanation information, warning information, classification information, and importance information. The server assigns classification values such as “explanation,” “risk_warning,” and “advice” to portions of the text. The server assigns importance values that reflect severity or priority, such as a numerical severity score or a discrete level like “low,” “medium,” or “high.” The server encodes the output data in a format suitable for transmission over the network. The terminal receives the output data and uses the classification and importance information to decide how to display the information, such as by rendering high-severity warnings with distinct visual emphasis or by reading them aloud first.
The server processes transaction information and asset information to generate risk-related data. The server retrieves transaction records for a user, including amounts, timestamps, counterpart identifiers, and categories. The server retrieves asset records, including account balances, investment holdings, and valuations. The server aggregates the transaction data by time period and expense category, computes features such as budget utilization rate, category-wise spending growth, and concentration of spending, and compares these features to user-defined or system-defined budget thresholds. The server then combines these features with risk signals from entity-level financial data to compute a composite risk indicator for the user or for a transaction counterpart. This risk-related data is encoded as a structured vector with named fields.
The server uses the risk-related data to generate a further prompt sentence that instructs the generative AI model to produce a warning message. An example of such a prompt sentence is:
“Based on the following risk-related data for the user's budget: budget utilization=95%, large upcoming payment=50,000 units, current savings ratio=low, generate a warning message that clearly informs the user that the risk of exceeding the monthly budget is high and suggests one or two specific actions to mitigate the risk.”
In another example, the server may generate a prompt sentence of the following form: “Based on the financial indicators of the transaction counterpart (liquidity ratio, equity ratio, leverage, risk score), generate a concise warning message describing potential transaction risk. Use precise and concrete language suitable for a user who is dissatisfied and requires clear justification.”
By centralizing the computation of risk-related data and passing only essential semantic attributes to the generative model, the server reduces the amount of data that must be transmitted and processed by the generative AI model. The system thus reduces communication load and computational overhead while still obtaining high-quality, context-aware warnings.
The server improves computer functionality by optimizing the data flow and representation across modules. The server maintains a unified internal schema for explanation data and risk-related data that binds numerical features and text fragments to stable identifiers. This reduces the need for repeated parsing and conversion between formats when passing data between modules. The server reuses intermediate representations across multiple user sessions where possible, caching feature vectors and prompt templates for commonly requested concepts. This caching reduces redundant computation and network calls, resulting in lower latency and lower resource consumption.
The server implements a training procedure for the risk evaluation model and the emotion estimation model. The server stores training data sets in the data storage device, including labeled historical financial outcomes and labeled emotion samples. The server applies a supervised learning algorithm such as stochastic gradient descent or Adam optimization to minimize an objective function such as cross-entropy loss between predicted probabilities and ground-truth labels. The server updates the parameters of the neural networks by computing gradients via backpropagation and applying weight updates. The server optionally uses data augmentation techniques, such as adding random noise to audio signals or applying affine transformations to face images, to improve robustness. Because the training process is carried out on the server using historical and feedback data, the system can adapt to domain-specific patterns and improve accuracy over time.
The server increases precision of explanations and warnings by feeding back user feedback into the system. The terminal provides interfaces that allow the user to rate explanation quality and to submit free text comments. The server stores these feedback entries and periodically runs a batch analysis process that correlates feedback with features of the underlying prompts, explanation data, and risk-related data. The server modifies prompt templates and mapping functions based on patterns in user feedback, such as consistently low ratings for overly technical responses. As a result, the system continuously tunes the prompt generation logic, thus improving the alignment of generative outputs with user needs while maintaining consistency with the computed data.
The system brings technical benefits that go beyond mere automation of human tasks. The server harmonizes multiple heterogeneous computational processes natural language parsing, database access, vectorized numerical computation, supervised risk modeling, emotion estimation, and generative text synthesis into a single orchestrated pipeline with explicit intermediate representations. The structured prompt sentence mechanism converts complex internal computation state into controlled input for the generative AI model, which is a technical solution that constrains and stabilizes the behavior of a neural language model within a data-centric environment. This design reduces error propagation, improves reproducibility, and decreases computation time compared to loosely coupled, ad hoc integration of similar components.
The system also operates in conjunction with physical terminal devices to control how and when information is presented to a user. The terminal adjusts the brightness, layout, and ordering of display elements based on classification and importance information, and prioritizes voice output of high-severity warnings. In this way, the system not only processes abstract data but also controls the operation and behavior of real display hardware and audio hardware in a systematic manner, improving the usability and safety of interactive information services.
Various modifications and alternative embodiments are possible within the scope of the claims. The server may use a different natural language processing framework, a different database system, or a different generative AI architecture, such as a recurrent neural network with attention mechanisms. The emotion estimation processing may be performed entirely on the terminal in some embodiments, and only emotion labels may be sent to the server. In other embodiments, the server may host an on-premise generative AI model rather than calling an external service. The numerical processing may use different feature sets or risk models tailored to other domains, such as technical diagnostics or operational monitoring, while still using the same structured prompt sentence mechanism to drive the generative AI model. All such variations may be implemented while maintaining the core technical structure in which the server unifies natural language analysis, structured data retrieval, numerical computation, emotion-aware control, and generative AI processing through explicit prompt sentences and structured intermediate data.

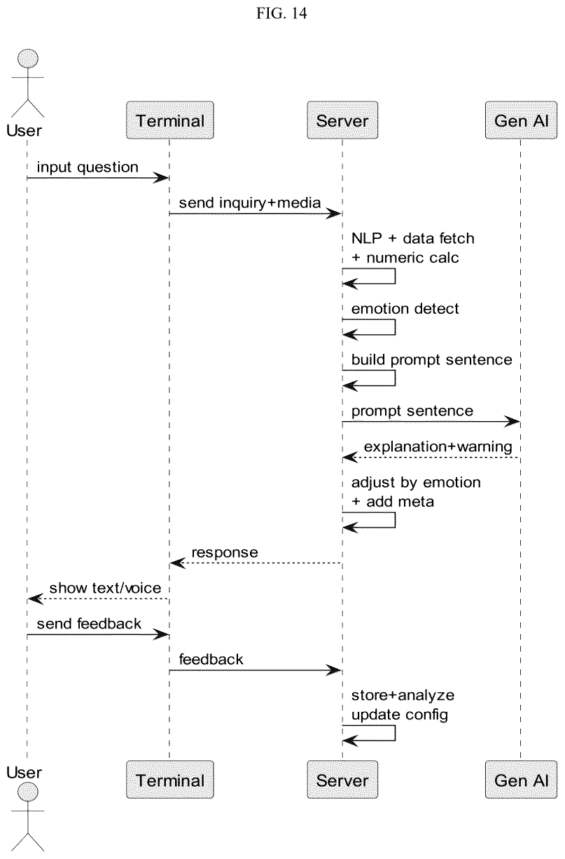

The following describes the processing flow using FIG. 14.
Step 1:
User operates the terminal and inputs inquiry information.
User enters a question, such as “What is EBITDA?” or “Is this company's financial position stable?”, through a keyboard, touch screen, or microphone.
Terminal receives the raw input as either character data or audio waveform.
Input: human speech or key/touch events.
Terminal converts key/touch events into UTF-8 text, or converts speech into text using a speech recognition engine, and generates an inquiry text string with a timestamp and a session identifier.
Output: structured inquiry information including inquiry text, timestamp, and session ID.
Step 2:
Terminal collects optional emotion-related media and user attributes.
Terminal activates a microphone and optionally a camera while the user is asking the question, after obtaining user permission.
Input: live audio samples and video frames from terminal hardware, and stored user attribute data such as language preference or expertise level.
Terminal compresses the audio (for example, to linear PCM or AAC) and video (for example, to H.264 or JPEG frames), and bundles these media objects together with the inquiry text and user attributes in a request payload.
Output: a request payload containing inquiry text, media samples, user attribute information, session ID, and user identifier.
Step 3:
Terminal transmits the request payload to the server.
Terminal establishes an HTTPS connection with the server and sends the payload using a predefined API endpoint.
Input: request payload constructed in Step 2.
Terminal serializes the payload as a structured message (for example, JSON over HTTPS) and writes the bytes to the network socket.
Output: a network message delivered to the server containing the inquiry text, media data, and metadata.
Step 4:
Server receives and validates the request payload.
Server accepts the HTTPS request through a web server component and forwards it to an application module.
Input: network message from the terminal.
Server parses the structured message, verifies that mandatory fields such as inquiry text and session ID are present, checks size limits for media attachments, and normalizes character encoding to UTF-8.
Output: an internal request object containing validated inquiry text, media references, user attributes, and session metadata.
Step 5:
Server performs natural language parsing and intent identification.
Server executes a natural language processing module on the inquiry text.
Input: normalized inquiry text from the internal request object.
Server tokenizes the text, performs part-of-speech tagging, and runs named-entity recognition to detect concept names, entity names, time expressions, and question type. Server applies an intent classifier to categorize the inquiry as, for example, “concept_explanation,” “entity_risk,” or “budget_impact.”
Server stores the parsed elements in a structured representation (for example, a dictionary with slots “target_concept,” “target_object,” and “intent_type”).
Output: a parsed inquiry structure including target concept, target object, and intent type.
Step 6:
Server retrieves related information from storage and external sources.
Server chooses data sources based on the intent type and the identified entities.
Input: parsed inquiry structure from Step 5.
For a concept_explanation intent, server constructs a database query to a relational database that stores concept definitions and indicator descriptions, and retrieves definition text associated with the target concept.
For an entity_risk intent, server calls a financial data service or queries a local financial data store to retrieve time-series balance sheet, income statement, and cash-flow records for the target object.
For a budget_impact intent, server queries a transaction history table storing user-level transaction data and budget settings.
Server aggregates the retrieved records into a consistent schema and resolves any missing or conflicting values.
Output: a related information set containing definition information, numerical information, and historical information.
Step 7:
Server loads numerical information into a structured numerical representation.
Server uses a numerical library to create a table-like data structure for computation.
Input: numerical and historical information from Step 6.
Server instantiates a DataFrame-like object with columns for financial attributes (for example, current assets, current liabilities, equity, operating profit, cash flow, transaction amount) and rows indexed by time or entity. Server converts raw values to a unified numeric type, applies currency conversion if needed, and fills missing entries using interpolation or default rules.
Output: a normalized numerical data structure ready for vectorized computation.
Step 8:
Server performs numerical computation and risk evaluation.
Server computes financial indices and statistical measures using the numerical data structure.
Input: normalized numerical data structure from Step 7.
Server calculates derived indices such as liquidity ratio, equity ratio, leverage ratio, free cash flow, and budget utilization by applying arithmetic operations across columns. Server computes statistical values like moving averages, variances, and trend slopes by running aggregation functions over time windows.
Server extracts feature vectors from the numerical data, such as leverage, cash-flow trend, and earnings volatility, and inputs these features into a pre-trained risk model (for example, a gradient-boosted ensemble or logistic regression). The risk model computes a continuous risk score representing probability of a predefined adverse event.
Output: explanation data that includes computed index values, statistical values, and risk scores, linked to the target concept or target object.
Step 9:
Server executes emotion estimation using media and text.
Server determines user emotion from available media or text.
Input: audio samples, video frames, and optionally the inquiry text from the internal request object.
Server extracts features from the audio (such as pitch contours, energy, spectral coefficients) and from the video (such as facial landmarks or facial action unit activations), and inputs these features into an emotion classification model. Alternatively or additionally, server analyzes sentiment of the inquiry text using a sentiment analysis model.
Server aggregates model outputs into a discrete emotion label (for example, “anxious,” “angry,” or “neutral”) and an intensity value.
Output: emotion information indicating the user's estimated emotional state and intensity.
Step 10:
Server constructs a structured prompt sentence for the generative AI model.
Server uses the explanation data, emotion information, and user attributes to build a detailed prompt.
Input: explanation data from Step 8, emotion information from Step 9, parsed inquiry structure from Step 5, and user attribute information from Step 2.
Server selects a prompt template according to the intent type and desired structure (for example, separate sections for explanation and warning). Server fills the template with: (i) the user's original question; (ii) essential numerical results and risk scores; (iii) contextual details such as time period or entity type; and (iv) expression conditions such as desired tone, level of detail, and length.
For example, server may generate the prompt sentence:
“The user asks: ‘What is EBITDA?’. Use the following base definition: ‘EBITDA is operating profit plus depreciation and amortization and indicates a company's earning power.’ Generate a concise, clear explanation for a non-expert. Avoid technical jargon and keep the answer under 120 words.” Or, for a risk case:
“The user is anxious and asks: ‘Is this company's financial position stable?’. Here are the latest financial indicators: liquidity ratio=1.8, equity ratio=35%, debt ratio=60%, free cash flow trend=decreasing, risk score=0.4. Explain the current financial stability in simple terms and mention any future risks. Use a calm, reassuring tone, and provide one practical suggestion.”
Output: a prompt sentence string that encodes context, numerical results, emotion constraints, and presentation rules.
Step 11:
Server interacts with the generative AI model to obtain explanation and warning text.
Server submits the constructed prompt sentence to a generative AI model.
Input: prompt sentence from Step 10.
Server transmits the prompt to an AI inference endpoint, specifying generation parameters such as maximum token count and sampling settings. The generative AI model processes the prompt and returns a sequence of tokens. Server decodes the tokens into a text string and optionally splits the result into labeled segments, such as “explanation” and “warning,” using separators or patterns specified in the prompt.
Output: generated explanation information and, when applicable, generated warning information as text.
Step 12:
Server adjusts generated text based on emotion and system rules.
Server refines the explanation and warning text using emotion information and system-specific constraints.
Input: generated explanation and warning text from Step 11, emotion information from Step 9, and classification rules stored in configuration.
If the emotion label indicates anxiety, server may reduce technical complexity by simplifying sentences and appending softening phrases. If the emotion indicates anger or dissatisfaction, server may replace vague statements with explicit, directive phrases. Server may optionally re-submit a secondary prompt to the generative AI model, such as “Rephrase the following explanation in a gentle, reassuring tone: [text],” to obtain a modified version consistent with the emotion.
Output: adjusted explanation information and adjusted warning information tailored to the user's emotional state and system rules.
Step 13:
Server assembles output data and adds classification and importance metadata.
Server packages the text segments into a structured response object.
Input: adjusted explanation and warning text from Step 12, explanation data from Step 8, and risk scores.
Server assigns classification labels (for example, “explanation,” “risk_warning,” “advice”) to each text segment and computes importance or severity levels based on risk scores and threshold rules (for example, mapping high risk scores to “high” severity). Server also attaches summarized numerical values, such as key ratios, to the response object for optional display.
Output: an output data object containing explanation information, warning information, classification information, importance information, and associated numerical summaries.
Step 14:
Server transmits the output data to the terminal.
Server sends the structured response back to the user's device.
Input: output data object from Step 13 and session metadata.
Server serializes the response as a structured message and writes it to the network connection corresponding to the session. The message includes correlation identifiers so that the terminal can associate the response with the original inquiry.
Output: a network response delivered to the terminal containing all content and metadata needed for presentation.
Step 15:
Terminal renders visual and audio output for the user.
Terminal interprets the structured response and displays it.
Input: output data received from the server in Step 14.
Terminal parses classification and importance information and arranges the text on the display device, for example showing explanations in a main area and warnings in a highlighted panel. Terminal may emphasize high-severity warnings using color, icons, or larger font size. Terminal optionally invokes a text-to-speech engine to read high-severity warnings aloud.
Output: visual content on the display device and, if enabled, audio output from the speaker, presenting explanation and warning information to the user.
Step 16:
User reviews the content and provides optional feedback.
User reads or listens to the explanation and warning and then may indicate satisfaction or dissatisfaction.
Input: displayed information and user perception.
User interacts with feedback controls, such as rating buttons or a comment field, and submits feedback about clarity, usefulness, or tone. Terminal converts these actions into structured feedback data with ratings and optional text comments.
Output: feedback data associated with the original session and inquiry.
Step 17:
Terminal transmits feedback data to the server.
Terminal sends the feedback for storage and later analysis.
Input: feedback data from Step 16.
Terminal packages the feedback with the session ID and user identifier in a structured message and sends it via the same secure communication channel to a feedback endpoint on the server.
Output: a feedback request delivered to the server.
Step 18:
Server stores feedback and updates internal models and templates over time.
Server records and analyzes feedback to refine processing behavior.
Input: feedback data received from the terminal, together with logs of prompts, explanation data, and generated texts for the corresponding session.
Server writes feedback entries into a feedback table in persistent storage. Periodically, server runs an analysis job that aggregates feedback by concept, by prompt template, and by emotion category. Server identifies patterns, such as low ratings for long explanations or for insufficiently direct warnings, and modifies prompt templates, tone mappings, and risk thresholds accordingly. Server may also use feedback data as labels for further fine-tuning of risk models or emotion mappings.
Output: updated configuration parameters, refined prompt templates, and potentially re-trained auxiliary models that improve subsequent runs of Steps 5 through 13.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

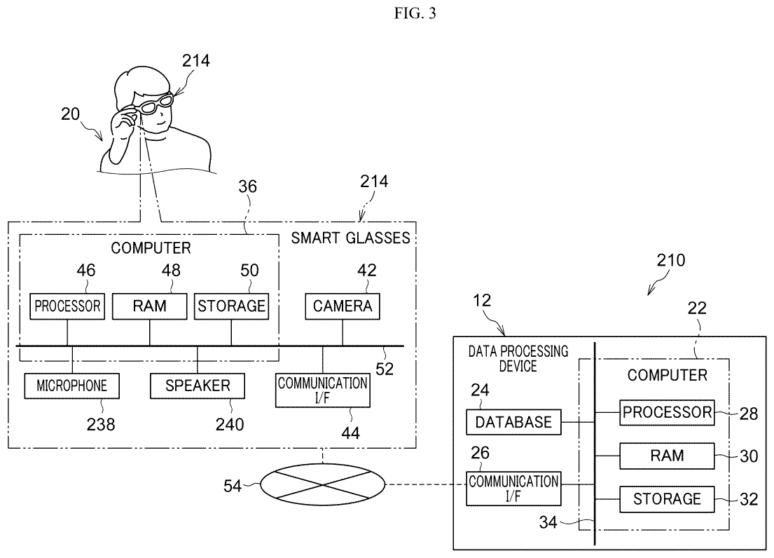

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

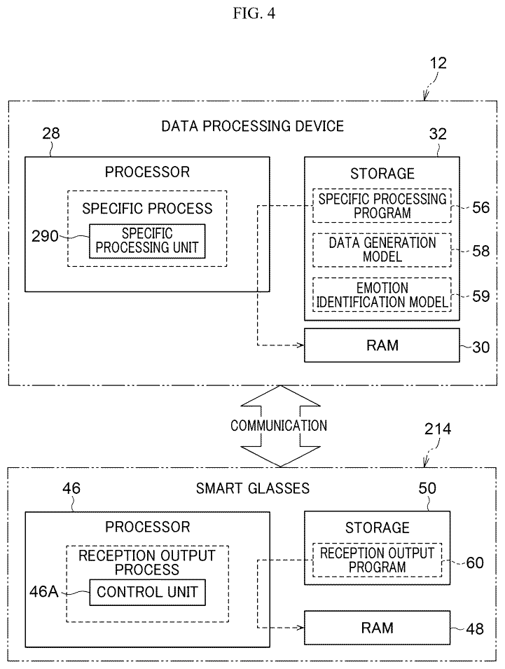

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

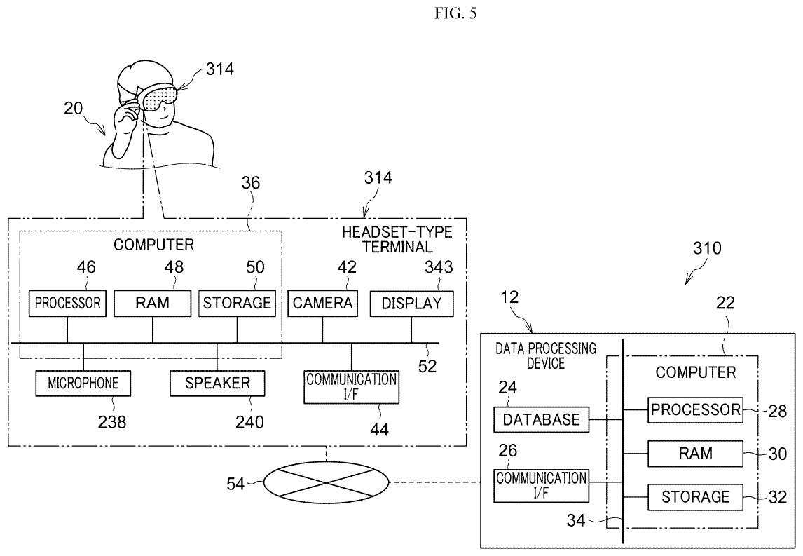

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

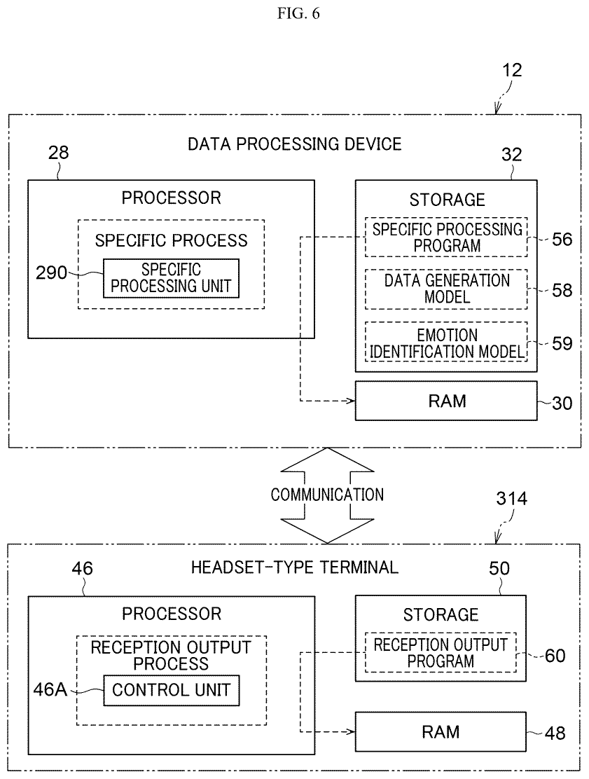

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.
Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïe Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

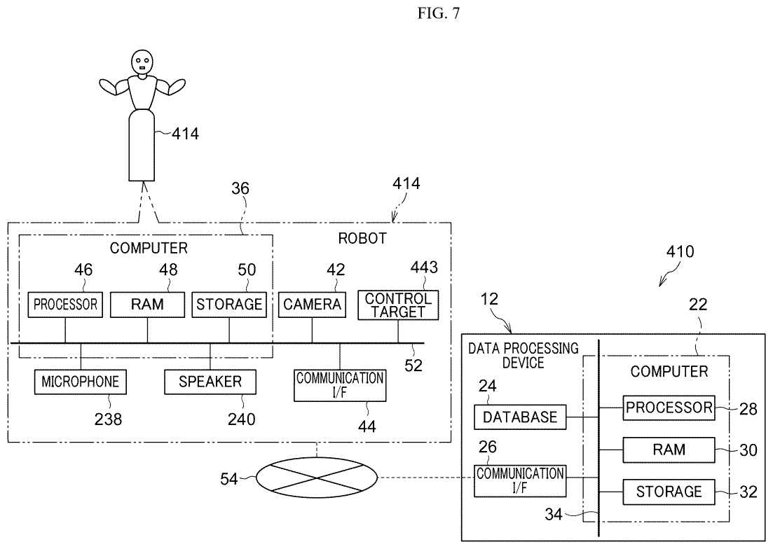

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

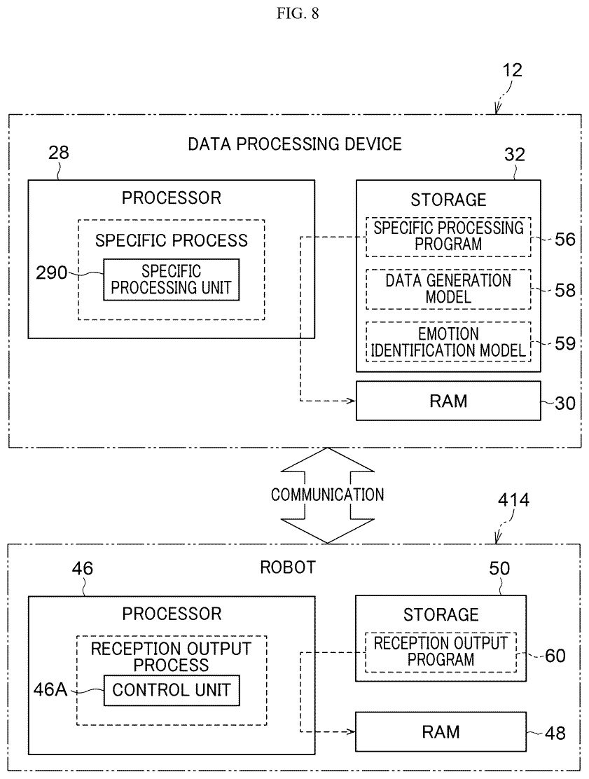

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

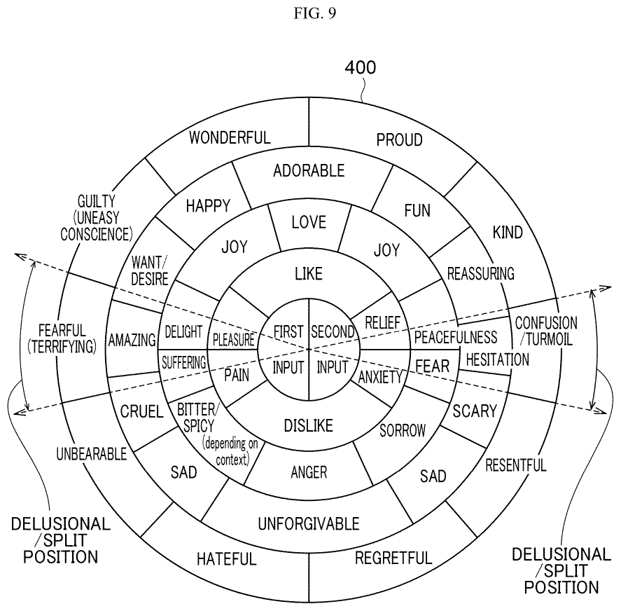

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

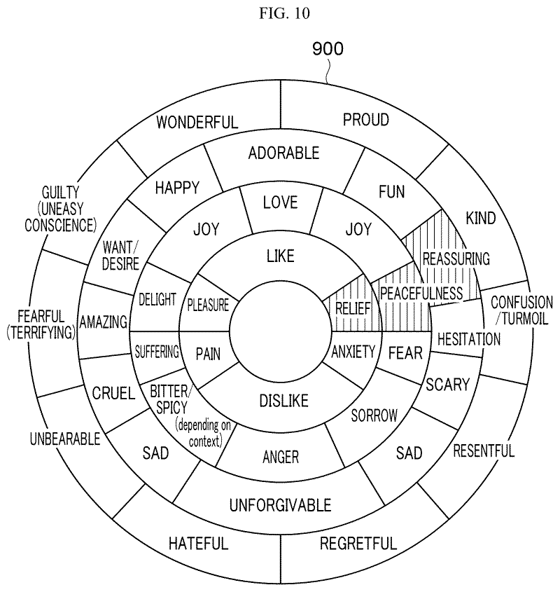

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a storage device, a communication interface, and a terminal device,
wherein the processor is configured to provide, via the terminal device, an input/output interface that receives a prompt sentence representing a natural language question from a user and displays an input field for the prompt sentence and a transmission control,
acquire financial information from an external information processing apparatus via an electric communication line through the communication interface, store the acquired financial information in the storage device, and perform numerical computation on the financial information to calculate and update financial indicators and financial ratios,
preprocess the prompt sentence received from the user via the terminal device by using a natural language processing technique, the preprocessing including document structure analysis, term extraction, and identification of attributes including a period and a financial instrument, and retrieve, from the storage device, data related to the prompt sentence from among the stored financial information,
generate, based on the retrieved financial information and the calculated financial indicators, a generation prompt sentence to be input to a generative AI model, the generation prompt sentence including instruction information that defines a financial concept to be explained, numerical data to be used, a level of detail of an explanation, and an output format,
transmit the generation prompt sentence to the generative AI model via the communication interface, obtain an explanation text output from the generative AI model, and perform formatting processing and numerical-example insertion processing on the explanation text to generate explanation information regarding the financial concept,
extract, as visualization data corresponding to the explanation information, time-series data and category data from the financial information and the financial indicators, and generate structured data for graph display or table display on the terminal device,
present, via the terminal device, the explanation information and visual information based on the structured data to the user as a textual display and a graphical display, receive evaluation information and an additional prompt sentence from the user via the terminal device, and store the evaluation information and the additional prompt sentence in the storage device, and update, on the basis of the stored evaluation information, a configuration rule of the generation prompt sentence and instruction content to the generative AI model so as to adjust content and a level of detail of a subsequent explanation generation process.

### Supplementary 2

The system according to supplementary 1,
wherein the processor is configured to cause the terminal device to receive explanation information as text information for audio output, to execute a speech synthesis process on the text information to generate an audio signal, to present the audio signal to the user, and to receive, from the terminal device, operation information and evaluation information regarding the audio output.

### Supplementary 3

The system according to supplementary 1,
wherein the processor is configured to analyze financial-related data acquired from the user together with the financial information stored in the storage device, to generate a generation prompt sentence that causes the generative AI model to generate a warning message regarding a specific financial risk, to input the generation prompt sentence to the generative AI model, to obtain the warning message output from the generative AI model, and to present the warning message to the user via the terminal device.

### Application Example 1

### Supplementary 1

A system comprising a processor,
wherein the processor is configured to receive, via an input/output device, a natural language question and user identification information from a user terminal,
obtain, from a remote storage device, user transaction history information and income/expense information based on the user identification information, and convert the transaction history information and the income/expense information into financial status summary data including category-based expenditure amounts, period-based expenditure amounts, income amounts, and saving rates by performing aggregation processing and statistical processing,
apply a natural language processing program to the question to perform morphological analysis and semantic analysis, extract intent information and finance-related keywords from the question, and identify a financial support type based on the intent information,
generate a descriptive text including the financial status summary data, the financial support type, and the question, and configure a prompt sentence to be input to a generative artificial intelligence model by using the descriptive text, thereby instructing the generative artificial intelligence model to generate an explanation or advice regarding a specific financial concept,
receive the explanation or the advice output from the generative artificial intelligence model, perform post-processing including rounding of currency amounts and normalization of expression formats, and transmit the post-processed explanation or advice to the user terminal, and
control presentation of the explanation or the advice on the user terminal by causing the explanation or the advice to be displayed as character information and, as needed, output as audio information using a speech synthesis program.

### Supplementary 2

The system according to supplementary 1,
wherein the processor is configured to add structured data including expenditure classification information and reduction-candidate classification information contained in the financial status summary data in association with the explanation or the advice output from the generative artificial intelligence model, and transmit the structured data to the user terminal so that expenditure reduction candidates by classification are visually presented on the user terminal.

### Supplementary 3

The system according to supplementary 1,
wherein the processor is configured to add numerical indicators and condition information including at least one of an expenditure reduction rate, a saving target, and an investment policy to the prompt sentence to be input to the generative artificial intelligence model, and instruct generation of specific and actionable financial advice by the generative artificial intelligence model based on the numerical indicators and the condition information.

### Example 2

### Supplementary 1

A system comprising a processor,
wherein the processor is configured to control an input/output device of a terminal to receive question data expressed in natural language from a user and to transmit the question data from the terminal to a server via a communication network,
analyze, in the server, the received question data by performing preprocessing with a natural language processing algorithm to extract intent information and keyword information, search, in the server, based on the keyword information, concept information and example information stored in a knowledge information storage device, and acquire the concept information and the example information according to relevance,
generate, in the server, structured information including the concept information and the example information, generate a prompt sentence including the structured information and the question data, and input the prompt sentence to a generative artificial intelligence model, analyze, in the server, a token sequence output from the generative artificial intelligence model to generate explanation text, and transmit the explanation text as response data to the terminal, and
control the terminal to extract the explanation text from the received response data and to visually present the explanation text on a display device.

### Supplementary 2

The system according to supplementary 1,
wherein the processor is configured to generate, in the server, control parameters including intent type information, detail level information, and explanation style information for the question data and the structured information, and add the control parameters to the prompt sentence so as to control content and length of the explanation text generated by the generative artificial intelligence model.

### Supplementary 3

The system according to supplementary 1,
wherein the processor is configured to store, in a recording device, processing log information corresponding to the question data, the prompt sentence, and the explanation text, and update, based on the processing log information, generation rules of the prompt sentence and stored contents of the knowledge information storage device so as to improve accuracy of subsequent explanation text generation processing.

### Application Example 2

### Supplementary 1

A system comprising a processor,
wherein the processor is configured to receive inquiry information from a user terminal that includes a display device and an input device, and that is communicably connected to the system,
analyze the inquiry information by using a natural language processing technique so as to identify a target concept and a target object included in the inquiry information,
acquire related information including definition information, numerical information, and historical information from an information storage device or an external information providing device, based on the target concept and the target object,
integrate the related information and perform numerical processing including calculation of index values, calculation of statistical values, and risk evaluation, and format a result of the numerical processing as explanation data,
generate a prompt sentence including explanation content, warning content, and expression conditions, based on the explanation data, the inquiry information, and user attribute information, and instruct a generative AI model to input the prompt sentence, and construct output data including explanation information and warning information obtained from the generative AI model together with classification information and importance information, and transmit the output data to the user terminal.

### Supplementary 2

The system according to supplementary 1,
wherein the processor is configured to generate emotion information indicating a user emotional state by performing emotion estimation processing based on at least one of audio information, image information, and the inquiry information acquired from the user terminal, adjust at least one of a writing style, a level of detail, and an expression intensity of at least one of the prompt sentence, the explanation information, and the warning information in accordance with the emotion information, and cause the user terminal to present the adjusted explanation information and warning information.

### Supplementary 3

The system according to supplementary 1,
wherein the processor is configured to acquire transaction information and asset information relating to at least one of the user and a transaction counterpart, evaluate budget impact, spending tendency, and future risk in the numerical processing by using the transaction information and the asset information so as to generate risk-related data including an evaluation result, generate a prompt sentence that instructs generation of a warning message regarding a financial risk or a transaction risk based on the risk-related data, input the prompt sentence to the generative AI model, and cause the user terminal to present the warning message obtained from the generative AI model.

What is claimed is:

1. A system comprising:
circuitry configured to:
receive, via a communication interface coupled to a packet-switched network, a prompt sentence representing a natural language question from a terminal device, and preprocess the prompt sentence using a natural language processing technique comprising document structure analysis, term extraction, and identification of attributes including a period and an instrument type;
acquire related information from an external information processing apparatus via the communication interface, store the acquired information in a storage device, and perform numerical computation on the stored information to calculate and update numerical indicators and ratios;
retrieve, from the storage device, data related to the prompt sentence from among the stored information, and generate a prompt sentence based on the retrieved data and the preprocessed prompt sentence for instructing a generative AI model to generate explanatory content tailored to the natural language question;
input the generated prompt sentence to the generative AI model to obtain explanatory content, and transmit the explanatory content to the terminal device via the communication interface; and
receive sensor data from the terminal device, apply an emotion recognition model to the sensor data to generate an emotional state representation, and adjust a tone or content of subsequent explanatory content based on the emotional state representation.

2. The system according to claim 1, wherein the circuitry is configured to apply a voice tone analysis model to audio data received from the terminal device to extract prosodic features, apply a facial expression recognition model to image data received from the terminal device, and combine the prosodic features and a facial expression classification to generate the emotional state representation.

3. The system according to claim 2, wherein the circuitry is configured to update the prompt sentence with an instruction specifying a tone adjustment parameter based on the emotional state representation, and re-input the updated prompt sentence to the generative AI model to generate emotion-adapted explanatory content.

4. The system according to claim 3, wherein the circuitry is configured to select a content depth parameter from a predefined set comprising simplified, standard, and detailed levels based on the emotional state representation, and incorporate the content depth parameter in the updated prompt sentence.

5. The system according to claim 4, wherein the circuitry is configured to receive follow-up prompt sentences from the terminal device, maintain a dialog context across multiple turns, and incorporate the dialog context in subsequent prompt sentences for the generative AI model.

6. The system according to claim 1, wherein the circuitry is configured to acquire transaction information and asset information from the external information processing apparatus, evaluate numerical risk indicators comprising budget impact metrics, spending tendency metrics, and future risk metrics using the transaction information and the asset information, and generate risk-related data comprising an evaluation result.

7. The system according to claim 6, wherein the circuitry is configured to generate a prompt sentence instructing the generative AI model to generate a warning message based on the risk-related data, input the prompt sentence to the generative AI model, and transmit the obtained warning message to the terminal device.

8. The system according to claim 7, wherein the circuitry is configured to incorporate the emotional state representation as a tone adjustment parameter in the warning message generation prompt sentence, and adjust the presentation format of the warning message based on the emotional state representation.

9. The system according to claim 1, wherein the circuitry is configured to apply a named entity recognition model to the preprocessed prompt sentence to identify instrument-type entities and time-period entities, and use the identified entities as structured retrieval parameters for the storage device query.

10. The system according to claim 9, wherein the circuitry is configured to apply a semantic similarity model to the identified entities and the stored information to rank retrieved data items by relevance, and include only the highest-ranked data items in the prompt sentence for the generative AI model.

11. The system according to claim 1, wherein the circuitry is configured to apply numerical computation processing to the stored information to generate time-series indicators, and incorporate the time-series indicators as structured data fields in the prompt sentence.

12. The system according to claim 11, wherein the circuitry is configured to apply a trend detection model to the time-series indicators to identify directional patterns, and include identified patterns as condition parameters in the prompt sentence to guide the generative AI model's explanatory content generation.

13. The system according to claim 1, wherein the circuitry is configured to store a version history of prompt sentences, retrieved data, and generated explanatory content in the storage device, and apply an analysis model to the accumulated history to update retrieval parameters and prompt sentence generation rules.

14. The system according to claim 13, wherein the circuitry is configured to apply a query expansion model to prior prompt sentences to identify related terms, and use the related terms as additional retrieval parameters in subsequent data retrieval operations.

15. The system according to claim 1, wherein the circuitry is configured to acquire numerical data from a plurality of external information processing apparatuses via the communication interface, integrate the acquired data from different sources into a unified data representation, and apply a data normalization function to ensure consistent scale across heterogeneous numerical features.

16. The system according to claim 15, wherein the circuitry is configured to apply a cross-source consistency verification model to the integrated data to identify conflicting values, and apply a conflict resolution algorithm to generate a reconciled data set for storage in the storage device.

17. The system according to claim 1, wherein the circuitry is configured to apply a comprehension assessment model to response data received from the terminal device indicating user interaction with the explanatory content, and generate updated prompt sentences incorporating identified comprehension gaps for input to the generative AI model.

18. A system comprising:
circuitry configured to:
receive, via a communication interface coupled to a packet-switched network, a prompt sentence representing a natural language question from a terminal device, and preprocess the prompt sentence using a natural language processing technique comprising term extraction, named entity recognition, and identification of period and instrument-type attributes;
acquire related information from an external information processing apparatus, perform numerical computation to calculate numerical indicators and ratios, retrieve data related to the prompt sentence, and generate a prompt sentence for a generative AI model incorporating the retrieved data and preprocessed attributes;
apply a voice tone analysis model and a facial expression recognition model to sensor data from the terminal device to generate an emotional state representation, and adjust a tone or content depth parameter of subsequent prompt sentences based on the emotional state representation;
acquire transaction information and asset information, calculate risk indicators, generate a warning prompt sentence based on risk-related data, and input the warning prompt sentence to the generative AI model to obtain a warning message; and
transmit explanatory content and the warning message to the terminal device via the communication interface.

19. The system according to claim 18, wherein the circuitry is configured to store a version history of prompt sentences and generated content in the storage device, apply an analysis model to update retrieval parameters and prompt sentence generation rules based on accumulated history, and apply a query expansion model to identify related terms for use in subsequent data retrieval operations.

20. A method comprising:
receiving, via a communication interface coupled to a packet-switched network, a prompt sentence representing a natural language question from a terminal device, and preprocessing the prompt sentence using a natural language processing technique comprising document structure analysis, term extraction, and identification of attributes including a period and an instrument type;
acquiring related information from an external information processing apparatus via the communication interface, storing the acquired information in a storage device, and performing numerical computation on the stored information to calculate and update numerical indicators and ratios;
retrieving, from the storage device, data related to the prompt sentence from among the stored information, and generating a prompt sentence based on the retrieved data and the preprocessed prompt sentence for instructing a generative AI model to generate explanatory content tailored to the natural language question;
inputting the generated prompt sentence to the generative AI model to obtain explanatory content, and transmitting the explanatory content to the terminal device via the communication interface; and
receiving sensor data from the terminal device, applying an emotion recognition model to the sensor data to generate an emotional state representation, and adjusting a tone or content of subsequent explanatory content based on the emotional state representation.
